(19) United States
(12) Patent Application Publication
(10) Pub. No.: US 2006/0013462 A1
(43) Pub. Date: Jan. 19, 2006

(54) Image display system and method

(76) Inventor: Navid Sadikali, Kitchener (CA)

Correspondence Address: BERESKIN AND PARR, 40 KING STREET WEST, BOX 401, TORONTO, ON, M5H 3Y2, CA

(21) Appl. No.: 10/891,299

(22) Filed: Jul. 15, 2004

(51) Int. Cl. G06K 9/00; H05G 1/64; G06F 17/24

(52) U.S. Cl. 382/132; 378/98; 382/128; 715/517

(57) ABSTRACT

An image display system and method includes a tiling module, a closure module, a retiling module, and a mirroring module. Image display system displays studies on primary and supplemental displays in response to commands received from a user workstation. Display entities are displayed on display areas of primary and supplemental displays within display entity boxes that are defined by display entity layouts. As new display entities are added, they are added to the display areas in a preferred tiling format. Display entities are automatically closed when one display entity is dragged over another. Display entity boxes are dynamically resized which resulting in redefinition of display entity layouts. Various display entities can also be displayed on an original display and mirrored onto an adjacent display using an appropriate display protocol.

### FIELD OF THE INVENTION

This invention relates generally to the field of image display and more particularly to an improved image display system and method.

### BACKGROUND OF THE INVENTION

Commercially available image display systems in the medical field utilize various techniques to present image data to a user. Specifically, the image data produced within modalities such as Computed Radiograph (CR), Medical Resonance Imagery (MRI) and the like is displayed on a display terminal for review by a medical practitioner at a medical treatment site. This image data is used by the medical practitioner to determine the presence or absence of a disease, tissue damage etc. Many attempts to optimize the presentation of such image data to the medical practitioner have been made.

For example, U.S. Pat. No. 5,644,611 to McShane discloses an apparatus and method for maximizing the number of digital radiological images displayed on a display screen. Non-image portions of various medical image frames are reduced to maximize the number of images that can be presented on one image display screen. Also, the modified image frames are arranged on a display screen relative to one another in a plurality of rows and columns such that all image frames have the same widths and length.

Also, European Patent Application No. 1229458 to Shastri et al. discloses an image display method that provides a layout of image data based on a display protocol in which multiple display protocols are lined up in a predetermined order. The specific presentation protocols are stored in the memory of the displaying workstation such that a user can select a particular layout by specifying a particular display protocol sequence.

However, these image display systems only allow the medical practitioner to specify the specific output of image data in advance using preset preferences. Such preference-based systems do not allow the medical practitioner to dynamically interact with image data for optimal display purposes.

### SUMMARY OF THE INVENTION

The invention provides in one aspect, a display system for displaying a new display entity and a previous display entity, said system comprising:
(a) a memory for storing data associated with the new and previous display entities;
(b) a processor coupled to said memory for selectively retrieving data associated with the new and previous display entities;
(c) a primary display coupled to said processor for displaying the new and previous display entities, said primary display having a primary display area being adapted to display at least one display entity box according to a first display entity layout;
(d) said processor further being adapted to:
   (i) instruct the primary display to display the previous display entity in a display entity box defined by the first display entity layout;
   (ii) determine whether the new display entity has been selected for display;
   (iii) determine if primary display area is not full;
   (iv) if (ii) and (iii) are both true, close the display entity box defined by the first display entity layout and determine a second display entity layout which accommodates the new and previous display entities; and
   (v) display the new and previous display entities in the primary display area in display entity boxes that are defined by the second display entity layout.

The invention provides in another aspect, a method of displaying new and previous display entities on a primary display having a primary display area adapted to display at least one display entity box according to first display entity layout, said method comprising:
(a) storing data associated with the new and previous display entities;
(b) selectively retrieving data associated with the new and previous display entities;
(c) displaying the previous display entity on primary display in a display entity box defined by the first display entity layout;
(d) determining whether the new display entity has been selected for display;
(e) determining whether the primary display area is not full;
(f) if (d) and (e) are both true, closing the display entity box defined by the first display entity layout and determining a second display entity layout which accommodates the new and previous display entities; and
(g) displaying the new and previous display entities in primary display area in display entity boxes defined by the second display entity layout.

The invention provides in another aspect, a display system for displaying first and second display entities, said system comprising:
(a) a memory for storing data associated with the first and second display entities;
(b) a processor coupled to said memory for selectively retrieving image data associated with the first and second display entities;
(c) a display coupled to said processor for displaying the first and second display entities, said display having a display area being adapted to display at least one display entity box according to a display entity layout;
(d) said processor further being adapted to:
   (i) instruct the display to display the first and second display entities in the display area in display entity boxes defined by a first display entity layout;
   (ii) determine whether the second display entity has been selected for closure;
   (iii) if (ii) is true, close the at least one display entity box defined by the first display entity layout and determine a second display entity layout which accommodates the first display entity but not the second display entity; and
   (iv) display the first display entity in the display area in a display entity box defined by the second display entity layout.

The invention provides in another aspect, a method of displaying first and second display entities on a display having a display area adapted to display at least one display entity box according to a display entity layout, said method comprising:
(a) storing data associated with the first and second display entities;
(b) selectively retrieving data associated with said first and second display entities;
(c) displaying the first and second display entities in the display area in display entity boxes defined by a first display entity layout;
(d) determining whether the second display entity has been selected for closure;
(e) if (d) is true, closing the at least one display entity box defined by the first display entity layout and determining a second display entity layout which accommodates the first display entity but not the second display entity; and
(f) displaying the first display entity in the display area in a display entity box defined by the second display entity layout.

The invention provides in another aspect, a display system for displaying first and second display entities, said system comprising:
(a) a memory for storing data associated with the first and second display entities;
(b) a processor coupled to said memory for selectively retrieving data associated with the first and second display entities;
(c) a display coupled to said processor for displaying the first and second display entities, said display having a display area having left and top sides, said display also being adapted to display at least one first display entity box according to a first display entity layout and at least one second display entity box according to a second display entity layout;
(d) said processor being further adapted to:
   (i) instruct the display to display the first display entity in the first display entity box according the first display entity layout;
   (ii) determine whether a second display entity layout has been selected;
   (iii) if (ii) is true, close the first display entity box defined by the first display entity layout and display the first and second display entities within second display entity boxes defined by the second display entity layout.

The invention provides in another aspect, a method of displaying first and second display entities on a display having a display area having left and top sides, said display also being adapted to display at least one first display entity box according to a first display entity layout and at least one second display entity box according to a second display entity layout, said method comprising:
(a) storing image data associated with the first and second display entities;
(b) selectively retrieving image data associated with the first and second display entities;
(c) displaying the first display entity in the first display entity box according the first display entity layout;
(d) determining whether a second display entity layout has been selected; and
(e) if (d) is true, closing the first display entity box defined by the first display entity layout and displaying the first and second display entities within second display entity boxes defined by the second display entity layout.

The invention provides in another aspect, a display system for displaying a display entity, said display entity having display sub-entities, said system comprising:
(a) a memory for storing data associated with the display entity;
(b) a processor coupled to said memory for selectively retrieving data associated with the display entity;
(c) an original display coupled to said processor for displaying the display entity, said original display having an original display area adapted to display at least one display sub-entity;
(d) an adjacent display coupled to said processor for displaying the display entity, said adjacent display having an adjacent display area that is adapted to display at least one display sub-entity;
(e) said processor further being adapted to:
   (i) display the display entity within a display entity box within the original display area;
   (ii) determine whether mirroring of the display entity has been selected; and
   (iii) if (ii) is true, display the first display sub-entities of the display entity within the original display area and the second display sub-entities of the display entity within the adjacent display area.

The invention provides in another aspect, a method for displaying a display entity on an original display and an adjacent display, said display entity having display sub-entities, the original display having an original display area and the adjacent display, said method comprising:
(a) storing data associated with the display entity;
(b) selectively retrieving data associated with the display entity;
(c) displaying the display entity within a display entity box within the original display area;
(d) determining whether mirroring of the display entity has been selected; and
(e) if (d) is true, displaying the first display sub-entities of the display entity within the original display area and the second display sub-entities of the display entity within the adjacent display area.

Further aspects and advantages of the invention will appear from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show some examples of the present invention, and in which:

FIG. 1 is block diagram of the image display system of the image display system of the present invention;

FIG. 2 is a diagram illustrating in more detail the displays of the image display system of FIG. 1;

FIG. 3 is a flowchart illustrating the basic operational steps of the image display system of FIG. 1;

FIG. 4A is a flowchart illustrating the process steps conducted by the tiling module and the image processing module of FIG. 1 when executing the user-initiated tiling features;

FIG. 4B is a diagram illustrating the user-initiated tiling features provided by the tiling module of FIG. 1 when the user wishes to position a new study and or to reposition an existing study;

FIG. 4C is a flowchart illustrating the process steps conducted by the tiling module and the image processing module of FIG. 1 when executing the automatic tiling features;

FIGS. 4D, 4E, 4F, 4G, 4H, and 41 are diagrams illustrating the automatic tiling features provided by the tiling module of FIG. 1 when the user opens a new study without selecting a desired position;

FIG. 5A is a flowchart illustrating the process steps conducted by the closure module and the image processing module of FIG. 1;

FIGS. 5B and 5C are diagrams illustrating the image closure features provided by the closure module of FIG. 1;

FIG. 6A is a flowchart illustrating the process steps conducted by the retiling module and the image processing module of FIG. 1;

FIGS. 6B, 6C, 6D, 6E, 6F, 6G, 6H, and 61 are diagrams illustrating the retiling features provided by the retiling module of FIG. 1;

FIG. 7A is a flowchart illustrating the process steps conducted by the mirroring module and the image processing module of FIG. 1;

FIGS. 7B, 7C, 7D, and 7E are diagrams that illustrate the image mirroring features provided by the mirroring module of FIG. 1;

FIG. 8A is a flowchart illustrating the process steps conducted by the tiling and the image processing modules of FIG. 1 in respect of image display;

FIGS. 8B and 8C are diagrams that illustrate the “stack mode” image display functionality of the tiling and image processing modules of FIG. 1; and

FIGS. 8D and 8E are diagrams that illustrate the “tiling mode” image display functionality of the retiling and image processing modules of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

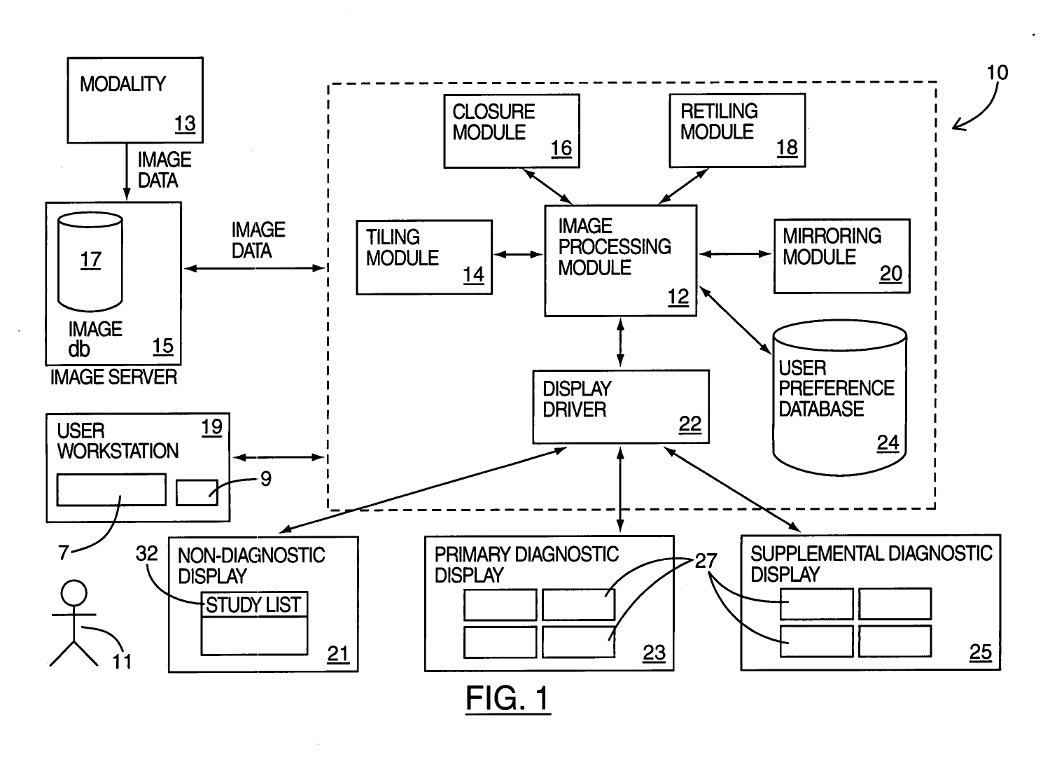

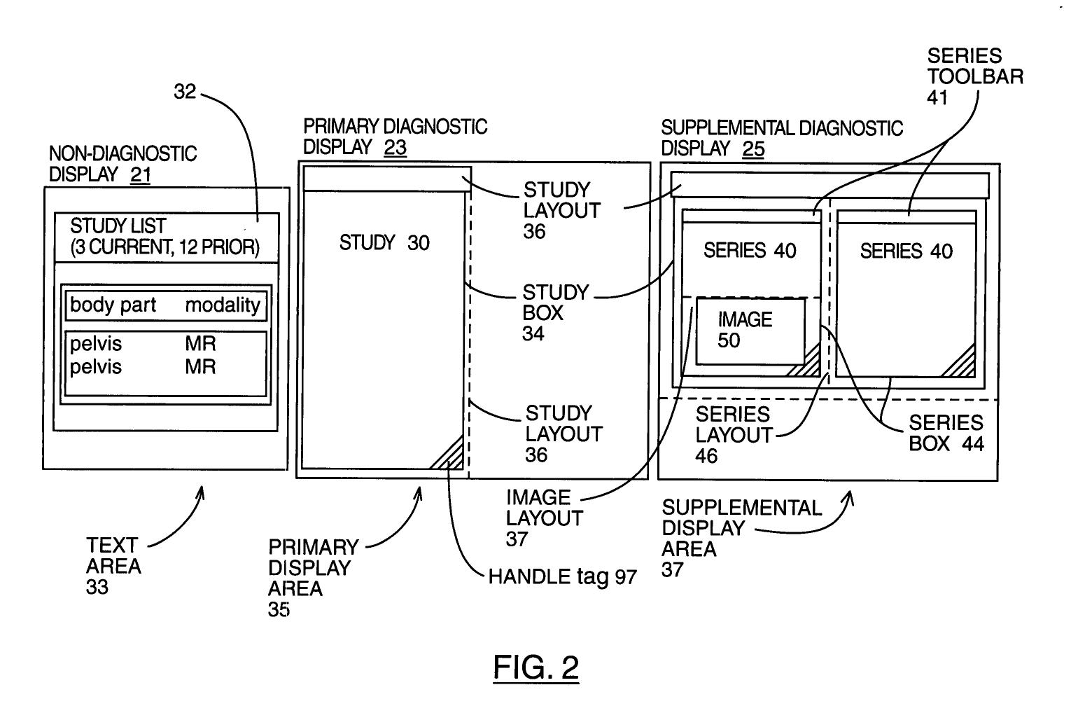

Reference is first made to FIGS. 1 and 2, which illustrates the basic components of an image display system 10 made in accordance with a preferred embodiment of the present invention. Image display system 10 includes an image processing module 12, a tiling module 14, a closure module 16, a retiling module 18, a mirroring module 20, a display driver 22, and a user preference database 24. As shown, image data associated with one or more display entities 27 (FIG. 1) (i.e. medical exams) is generated by a modality 13 and stored in an image database 17 on an image server 15 where it can be retrieved by image display system 10. Display entities 27 can be in various forms including studies 30, series 40, or images 50. In addition, it should be understood that one or more studies 30, series 40, or images 50 are typically associated with a particular patient. An index of studies 30 is provided in a study list 32 that is displayed on a non-diagnostic display 21. Image display system 10 provides image data associated with studies 30 through display driver 22 to primary and supplemental diagnostic displays 23, 25 in response to commands issued by a medical practitioner user 11 through user workstation 19 as shown. Image display system 10 works contextually and dynamically to allow for direct manipulation of studies 30 resulting in a more intuitive diagnostic environment for user 11.

User workstation 19 includes a keyboard 7 and a user-pointing device 9 (e.g. mouse) as shown in FIG. 1. It should be understood that user workstation 19 can be implemented by any wired or wireless personal computing device with input and display means (e.g. conventional personal computer, laptop computing device, personal digital assistant (PDA), etc.) User workstation 19 is operatively connected to non-diagnostic display 21, primary diagnostic display 23 and supplemental diagnostic display 25. Image display system 10 is used to provide image display formatting depending on user inputs through user workstation 19 and user pointing device 9. Image display system 10 is installed either on the hard drive of user workstation 19 and/or on a central image server such that user workstation 19 works with central image server in a client-server configuration.

Non-diagnostic display 21 is optimized for study 30 selection and provides a user with a study list 32 (FIG. 2). Study list 32 provides a textual format listing of display entities 27 (e.g. studies 30) that are available for display. Study list 32 also includes associated identifying indicia (e.g. body part, modality, etc.) and organizes studies 30 in current and prior study categories. Typically, user 11 will review study list 32 and select listed studies 30. When user 11 selects a study 30, the selected study 30 is displayed on primary diagnostic display 23 or supplemental diagnostic display 25, depending on how many study 30 are already displayed on primary and supplemental diagnostic displays 23 and 25, as will be discussed. Other associated textual information (e.g. patient information, image resolution quality, date of image capture, etc.) is simultaneously displayed within study list 32 to assist the user 11 in selection of studies 30. Non-diagnostic display 21 is preferably implemented using a conventional color computer monitor (e.g. a color monitor with a resolution of 1024×768) with sufficient processing power to run a conventional operating system (e.g. Windows NT). High resolution graphics are not necessary for non-diagnostic display 21 since this display is only displaying textual information to user 11.

Primary diagnostic display 23 provides high resolution image display of display entities 27 (e.g. studies 30) to user 11 on display area 35 (FIG. 2). The studies 30 displayed on primary diagnostic display 23 are typically current study 30 (i.e. image data from “today's” exam). As shown in FIG. 2, studies 30 are displayed within study boxes 34 that are defined within display area 35. Study boxes 34 have variable dimensions and are defined using an appropriate study layout 36 as will be described in more detail. Primary diagnostic display 23 is preferably implemented using medical imaging quality display monitors with relatively high resolution typically used for viewing CT and MR studies (e.g. black and white “reading” monitors with a resolution of 1280-1024 and up).

Supplemental diagnostic display 23 provides high resolution image display of study 30 to user 11 on display area 37 (FIG. 2). Supplemental diagnostic display 25 is typically used by user 11 to display another set of display entities 27 (e.g. studies 30 from a prior study) for comparison with the set of display entities 27 (e.g. studies 30 from a current study) shown on primary display 23. It has been determined that the left to right positioning of the three displays 12, 23 and 25 as shown in FIG. 2 is generally preferred by medical practitioner users 11 since it allows the eye to flow from left to right, from non-diagnostic display 21 to the diagnostic displays 23, 25. As shown in FIG. 2, studies 30 are again displayed within study boxes 34 that are defined within display area 37. Also, as noted above, study boxes 34 have variable dimensions and are defined using an appropriate study layout 36 as will be described. As with the primary diagnostic display 23, supplemental diagnostic display 25 is preferably implemented using medical imaging quality display monitors with relatively high resolution typically used for viewing CT and MR studies (e.g. black and white “reading” monitors with a resolution of 1280-1024 and up).

It should be understood that many other types of display configurations could be utilized within image display system 10 including the use of one, two or more displays.

Modality 13 is any conventional image data generating device (e.g. computed radiography (CR) systems, computed tomography (CT) scanners, magnetic resonance imaging (MRI) systems, positron emission tomography (PET), ultrasound systems, etc.) utilized to generate image data that corresponds to patient medical exams. The image data generated by modality 13 is then utilized for making a diagnosis (e.g. for investigating the presence or absence of a diseased part or an injury or for ascertaining the characteristics of the diseased part or the injury). Modalities 13 may be positioned in a single location or facility, such as a medical facility, or may be remote from one another. Image data from modality 13 is stored within image database 17 within an image server 15 as conventionally known.

Image processing module 12 coordinates the activities of tiling module 14, closure module 16, retiling module 18 and mirroring module 20 in response to user commands sent by user 11 from user workstation 19 and stored user display preferences from user preference database 25. Specifically, image processing module 12 is adapted to receive a request from user workstation 19 that indicates that particular display entities 27 (e.g. studies 30) being displayed on the various display monitors 21, 23 and 25 are to be displayed in a reformatted manner selected to improve the usability of the overall medical imaging system. The various types of image display formatting and display options provided by the present invention will be discussed.

Tiling module 14 is utilized by image processing module 12 to provide user 11 with tiling functionality within primary and supplemental display areas 35 and 37 (FIG. 2). As new display entities 27 (e.g. studies 30) are added, they are added to display areas 35, 37 in a preferred format. Specifically, study boxes 34 are added into a display area 35, 37 such that they share a proportional portion of display area 35, 37 with study boxes 34 that were already being displayed. In addition, as the maximum number of study boxes 34 (FIG. 2) are formed within display area 35, 37 studies 30 are “wrapped” over to the other display area 37, 35 according to a left-to-right or a right-to-left opening protocol. Tiling module 14 allows a user to compare various studies 30 by tiling them rather than by launching new overlapping image windows that block or cover existing study(ies) 30.

Closure module 16 is utilized by image processing module 12 to provide user 11 with image closure functionality within primary and supplemental display areas 35 and 37. Closure module 16 allows user 11 to directly manipulate the size and placement of display entities 27 (e.g. studies 30) within primary and supplemental display areas 35, 37 by dragging a desired study 30 over unwanted stud(ies) 30. This results in the unwanted study(ies) 30 being closed and the desired study 30 being resized to occupy in addition the display area previously taken by the unwanted studies 30.

Retiling module 18 is utilized by image processing module 12 to provide user-initiated retiling functionality within primary and supplemental display areas 35 and 37. Retiling module 18 allows user 11 to select display entities 27 (e.g. study boxes 34) and cause them to dynamically grow and shrink to fill all available space reducing the need for user 11 to specifically and individually resize studies 30 (i.e. reducing necessary user-interface interaction).

Mirroring module 20 is utilized by image processing module 12 to provide user 11 with image mirroring functionality within primary and supplemental display areas 35 and 37. Mirroring module 20 allows user 11 to continue the progress of display entities 27 (e.g. series 40 within a study 30, or images 50 within a series 40) across primary and supplemental display areas 35 and 37. The mirroring function uses a display protocol (e.g. “advanced by one”) to display related images within series 40 for a particular study 30 on original and adjacent displays as will be described.

Display driver 22 is a conventional display screen driver implemented using commercially available hardware and software. As shown in FIG. 2, display driver 22 ensures that various display entities 27 (e.g. studies 30, series 40, images 50, etc.) are displayed in a proper format within display areas 35, 37 using an appropriate layout (e.g. study layout 36, series layout 46, image layout 56, etc.)

Specifically, studies 30 are displayed within study boxes 34 that are defined within display areas 35, 37 using study layouts 36. Each study box 34 contains a study toolbar 31, as well as an series toolbar(s) 41 and an series box(es) 44. Each series box 44 is used to display a series 40. Study boxes 34 are defined within display areas 35, 37 using a study layout 36. Study layouts 36 are used to divide display areas 35, 37 into a number of regions within which study boxes 34 are arranged.

Similarly, series boxes 44 are defined within study boxes 34 using series layout 46 (FIG. 2). The particular limit of subdivided regions within a study layout 36 or a series layout 46 is only limited by the ergonomic limitations of the displays being used and user preferences. The specific choice of study layout 36 and series layout 46 is made by image processing module 12 according to which display feature (i.e. tiling, image closure, retiling or mirroring) is being activated by user 11.

Also, as shown in FIG. 2, images 50 can also displayed within series box 44 using an image layout 56. Images 50 are preferably provided without any special border or “box” around them, although it should be understood that images 50 could also be displayed in this fashion. Display driver 22 provides image data associated with studies 30 appropriately formatted so that studies 30 are properly displayed within a study box 34 and/or so that series 40 or images 50 are properly displayed within an series box 44.

While the functionality of image display system 10 will be discussed in relation to the display and arrangement of studies 30 within study boxes 34 in display area 35 (i.e. at the “study” level), it should be understood that the functionality of image display system 10 is equally applicable to the display and arrangement of any other display entity 27 within a prescribed display area (e.g. patient display boxes (not shown) within display area 35, series 40 and images 50 within series boxes 44, etc.) More generally, it should be understood that the functionality of tiling module 14, closure module 16, retiling module 18 and mirroring module 20 can be applied to any display system that is used to display display entities 27 to user 11.

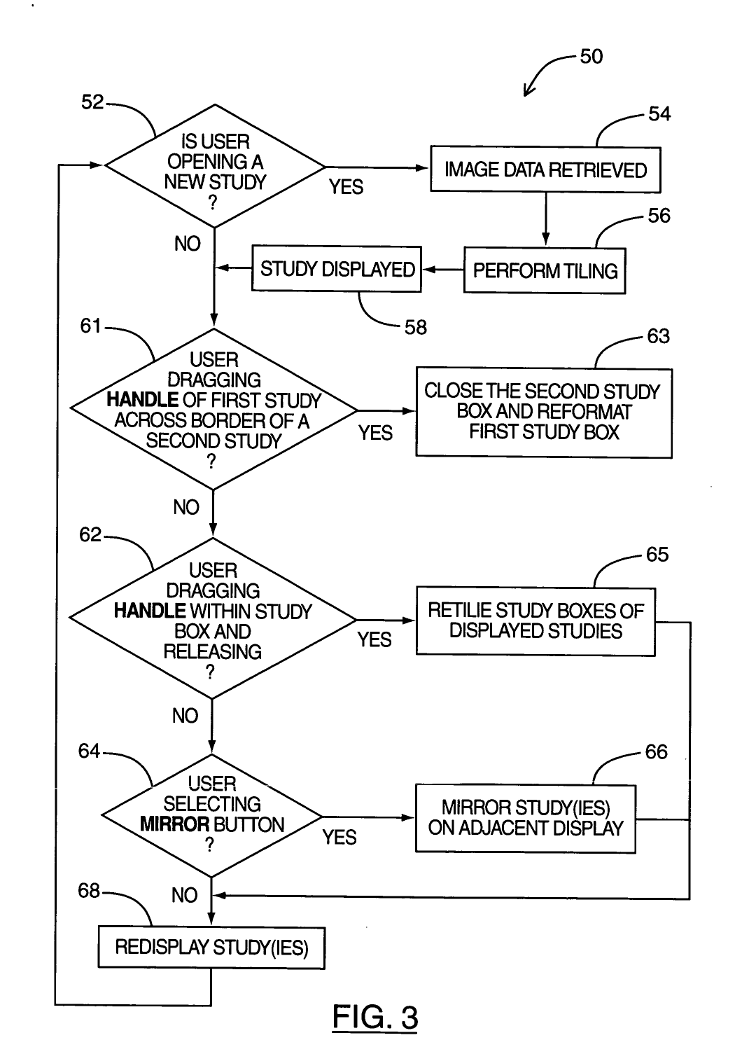

Referring now to FIGS. 1, 2, and 3, the basic operation of image display system 10 is illustrated. FIG. 3 illustrates the basic operational steps 50 of image display system 10. As noted above, while the general operation of image display system 10 will be discussed in respect of study(ies) 30, it should be understood that the tiling functionality described is equally applicable to any other kind of display entity 27 such as for example, individual series 40, images 50 and the like.

At step (52), it is determined whether user 11 is requesting the display of a new study 30 using keyboard 7 and/or mouse 9 of user workstation 19 (e.g. by clicking on desired studies 30 listed in study list 32 on non-diagnostic display 21). A user can open a new study 30 in at least two ways and in each case, tiling module 14 is activated, as will be described. First, user 11 can select a study 30 from a study list 32 on non-diagnostic display using a mouse 9 button and drag the study 30 to a particular location on primary or supplemental diagnostic display 23, 25 and then release the mouse 9 button. Second, user 11 can simply select a study 30 from study list 32 (e.g. by double clicking on the textual representation of study 30). It should be understood that these are only two exemplary methods of opening a new study 30 and that many other methods could be utilized and recognized by image processing module 12 as an indication to trigger tiling module 14.

If the user has requested display of a new study 30, then at step (54), image processing module 12 requests the image data associated with the requested new study 30 from image server 15. Image server 15 identifies the requested image data and retrieves it from image database 17. Then at step (56), image processing module 12 activates tiling module 14 to perform tiling in respect of the new study 30 as will be described in more detail. Generally speaking, a new study 30 selected by user 11 for display causes previous study(ies) 30 currently being displayed (if any) to be reformatted so that the previous study(ies) 30 and the new study 30 share a proportional portion of display area 35, 37 as defined by an optimized study layout 36. In addition, as the maximum number of study boxes 34 are formed within a display area 35 or 37 studies 30 are “wrapped” over to the other display area 37, 35 according to a left-to-right or a right-to-left opening protocol. These particular functions will be discussed in more detail. At step (58), the new study 30 along with any previous studies 30 are displayed within study boxes 34 as defined by an optimized study layout 36. That is, the image data associated with the new study 30 along with retiling instructions are provided to display driver 22. Display driver 22 in turn causes the new study 30 and any previous studies 30 to be displayed on primary and/or supplemental display 23, 25 as appropriate.

If the user 11 has not opened a new study 30 then it is determined whether user 11 is directly manipulating any of the studies 30. In order to directly manipulate a study 30, the user must first select a study 30 to manipulate. User 11 can select a study as discussed above, by selecting a study from study list 32. user 11 can also select a study 30 for direct manipulation by selecting (i.e. “clicking on”) any section of the study toolbar 31. In addition user 11 can select the HANDLE tag 97 associated with study 30 in order to change the dimensions of the study box 34.

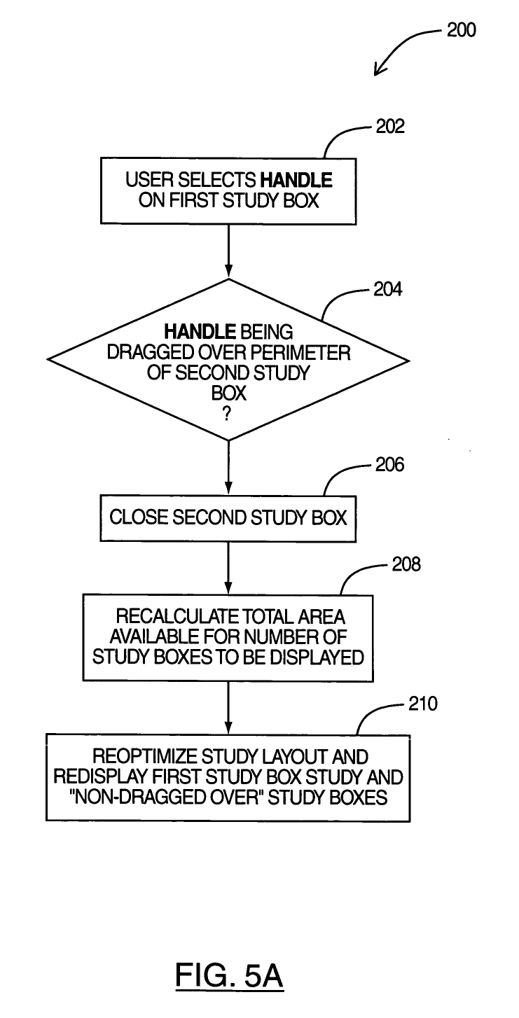

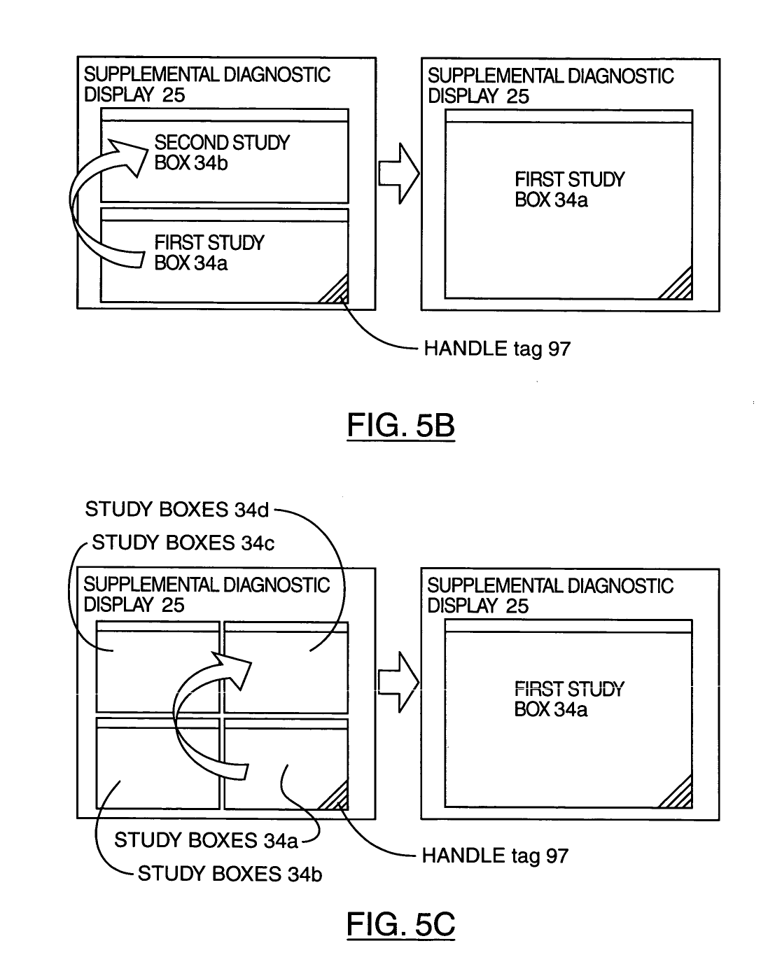

Specifically, at step (61), it is determined whether user 11 has dragged a first study 30a over a second study 30b. Typically, this function is used where user 11 is not interested in viewing the second study 30b any longer and wishes to increase the image area of the first study 30a. User 11 can accomplish such an effect by at least two ways. First, user 11 can drag a first study 30a over a second study 30b by selecting the HANDLE tag 97 (FIG. 2) associated with the first study 30a using a pointing device 9 and moving the HANDLE tag 97 of the first study 30a over an (e.g. bottom) edge of the study box 34 of the second study 30b (FIG. 5B). Secondly, user 11 can draft a first study 30a over a second study 30b by selecting the study toolbar 31 associated with the first study 30a and dragging it over an edge (e.g. bottom) edge of the study box 34 of the second study 30b.

If user 11 has dragged first study 30a over a second study 30b, then at step (63), image processing module 12 activates closure module 16 to close second study 30b. At step (65), image processing module 12 activates retiling module 18 to resize the study box 34 associated with first study 30 to take advantage of the display area freed up by the recently closed second study 30b as will be described.

At step (62), it is determined whether user 11 has directly requested retiling of a study 30. Specifically, user 11 indicates that retiling is desired when user 11 selects the graphical HANDLE tag 97 at the bottom right corner of study box 34 and drags it within study box 34 to form a resized study box 34. Alternatively, user 11 can also activate the retiling functionality of retiling module 18 through a button/pull down menu located within study toolbar 31.

If user 11 has directly requested retiling of a study 30 then at step (65), image processing module 12 activates retiling module 18 to conduct retiling. First retiling module 18 determines the appropriate study layout 36 that most closely matches the retiling study box produced by the user 11 in dimension. Once user 11 releases the HANDLE tag 97, then retiling module 18 utilizes the selected study layout 36 associated with the last selected resized study box and uses it to redisplay all displayed study(ies) 30 within the study layout 36 as will be described.

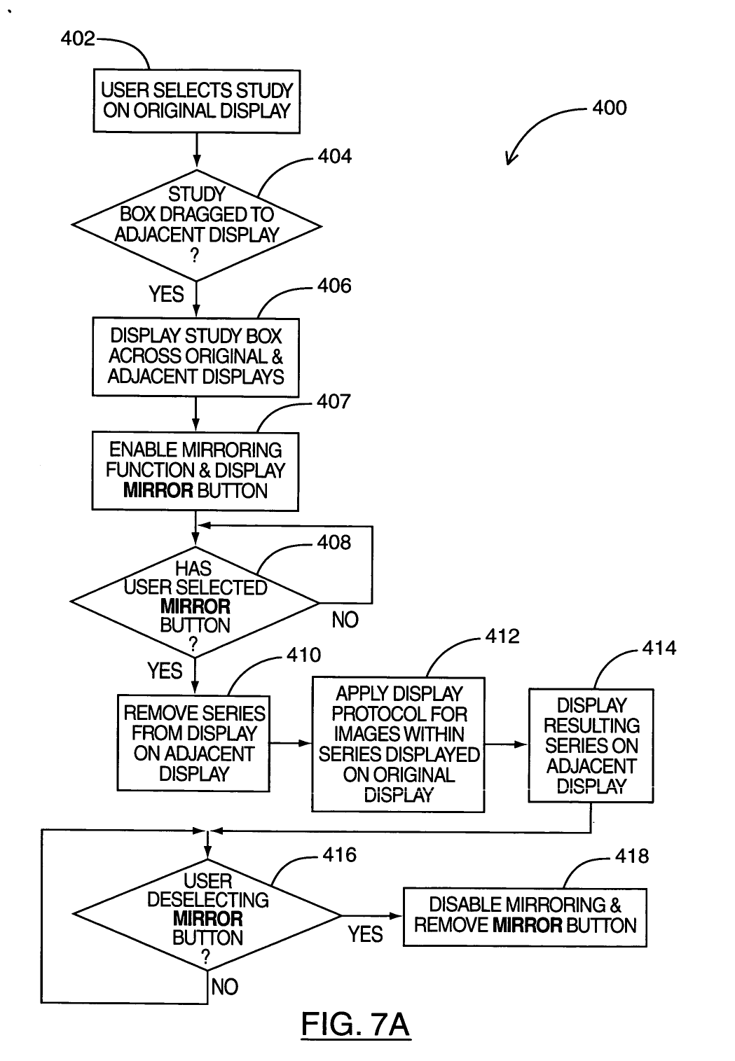

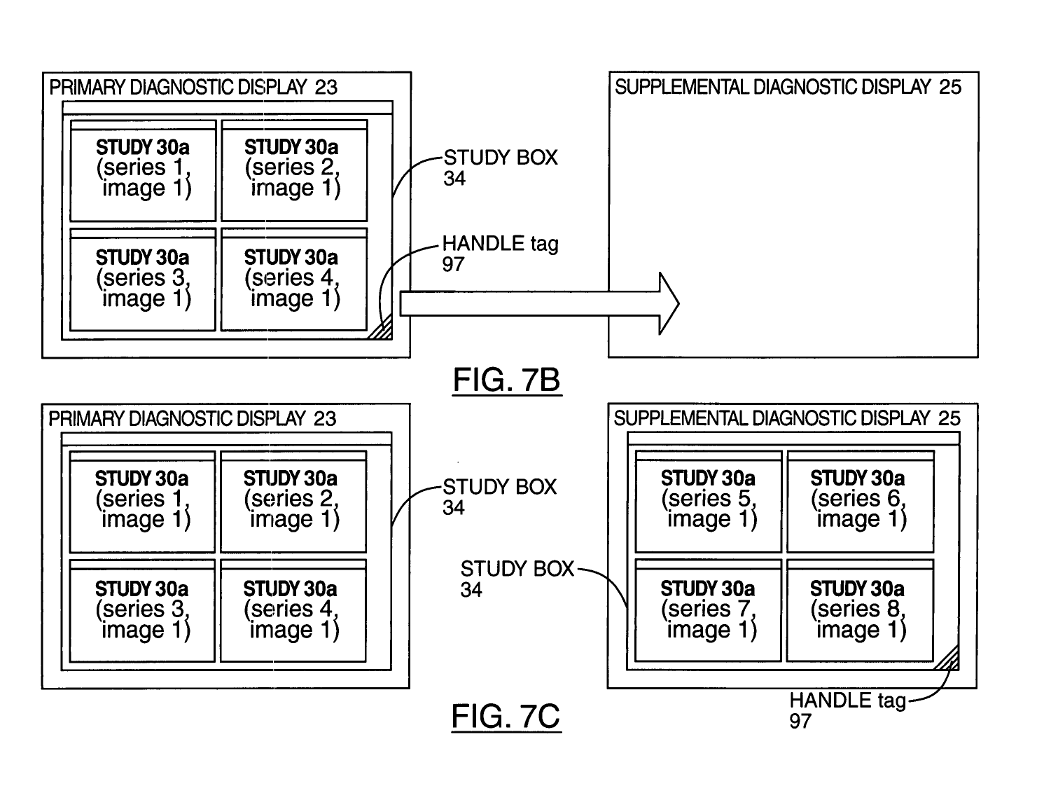

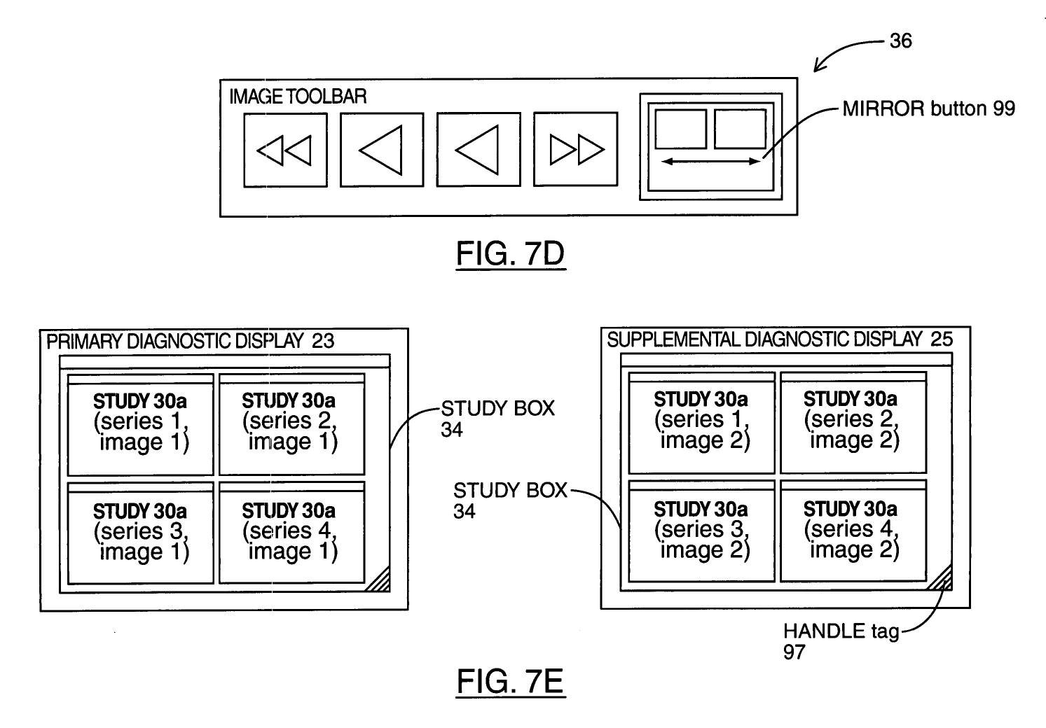

At step (64), it is determined whether user 11 has selected mirroring functionality. A user 11 selects mirroring of an image series currently being displayed on an original diagnostic display (e.g. primary diagnostic display 23) by first enabling the adjacent diagnostic display (e.g. supplemental diagnostic display 25) by dragging a study 30 over to that area and then by selecting the MIRROR button 99 (FIG. 7B) that appears within study toolbar 31 as a result. By executing these steps, the user 11 indicates a desire to display a mirrored series on the adjacent diagnostic display (e.g. supplemental diagnostic display 25).

If user 11 requests mirroring functionality, then at step (66), image processing module 12 activates mirroring module 20 to conduct mirroring of studies 30. Mirroring module 30 takes the series 40 of a particular study 30 being displayed on an original diagnostic display (e.g. primary diagnostic display 23) and displays a particular image set (e.g. the second image of each series 40) on the adjacent diagnostic display (e.g. supplemental diagnostic display 25) according to a display protocol as will be further described.

At step (68), the image data associated with the requested study(ies) 30 along with retiling instructions are provided to display driver 22. Display driver 22 in turn causes the new study 30 to be displayed on primary and/or supplemental display 23, 25 as appropriate. All study(ies) 30 to be displayed are resized and reformatted using the functionality of tiling module 14, closure module 16, retiling module 18 and mirroring module 20 as well as preferred default display settings selected by user 11 and stored in user preference database 24.

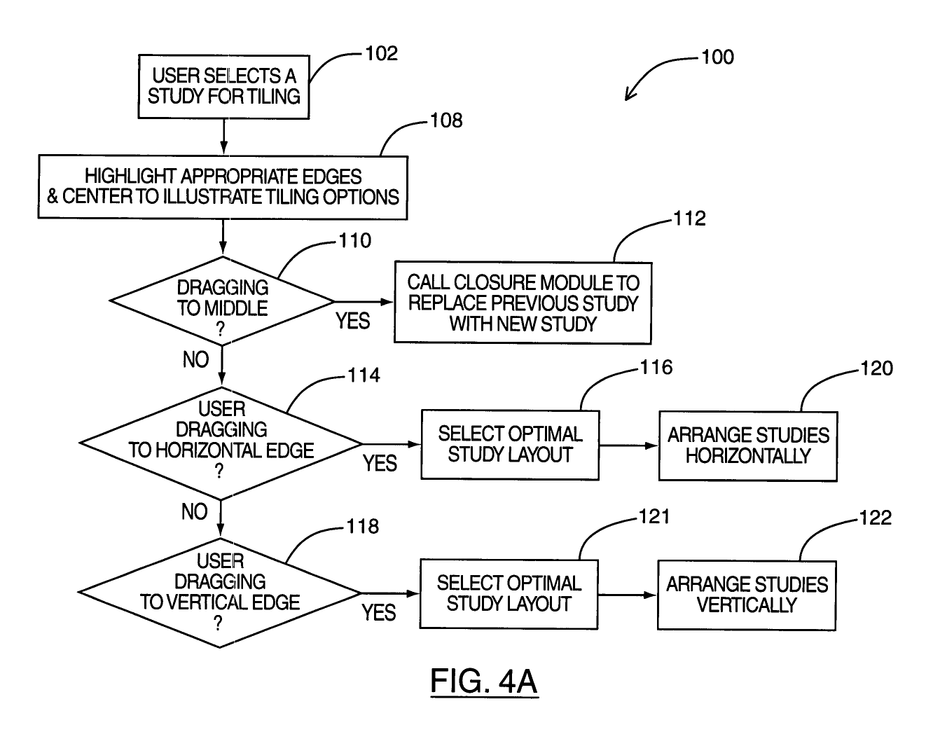

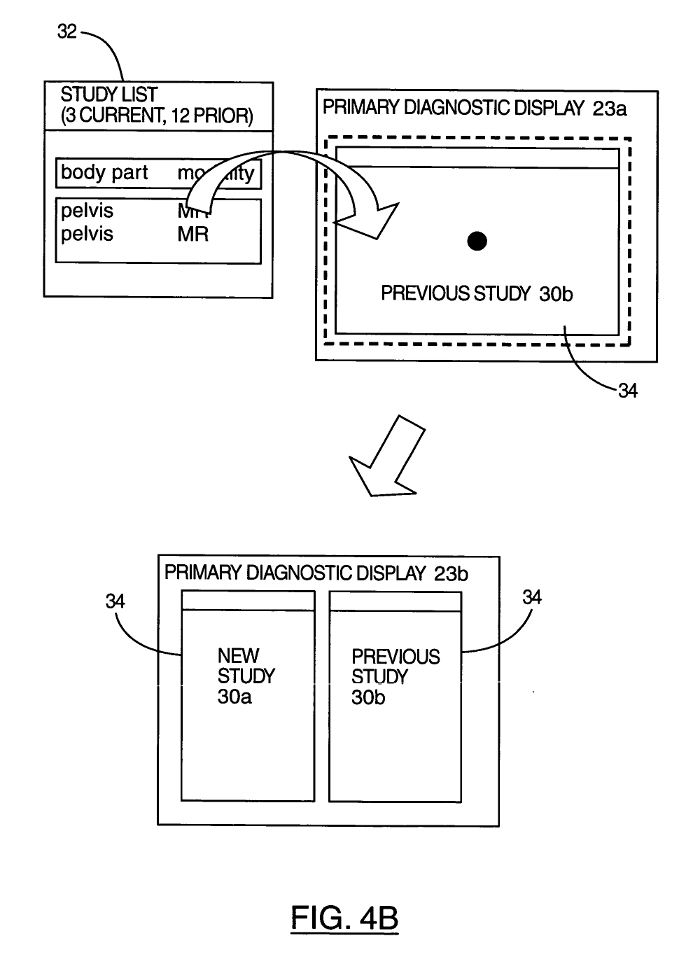

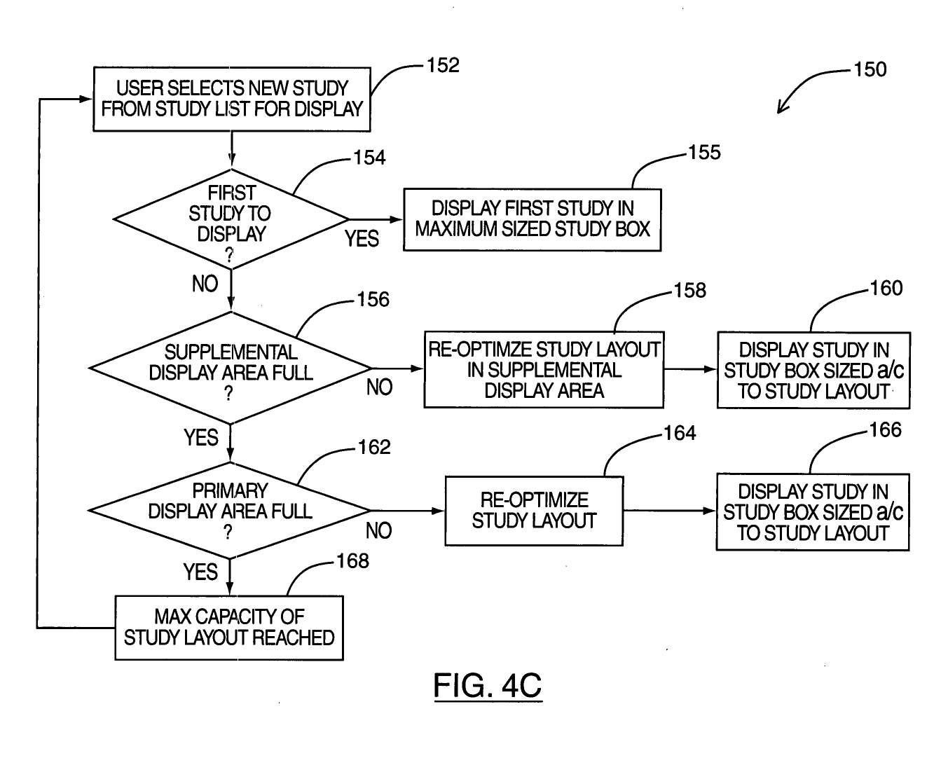

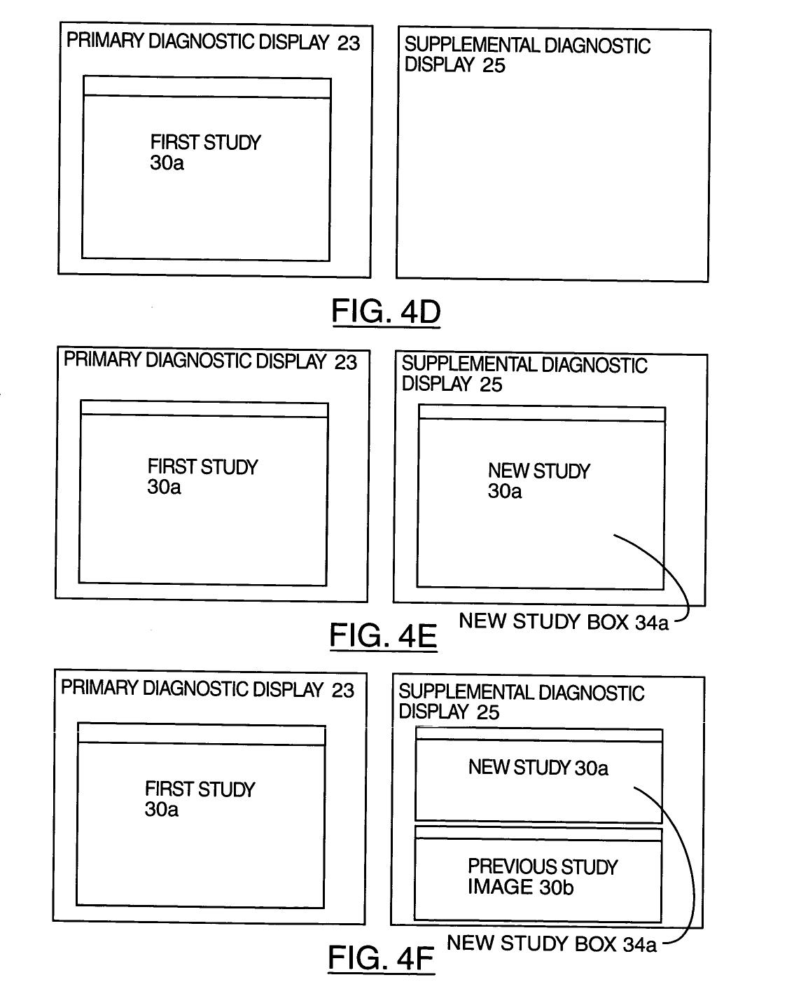

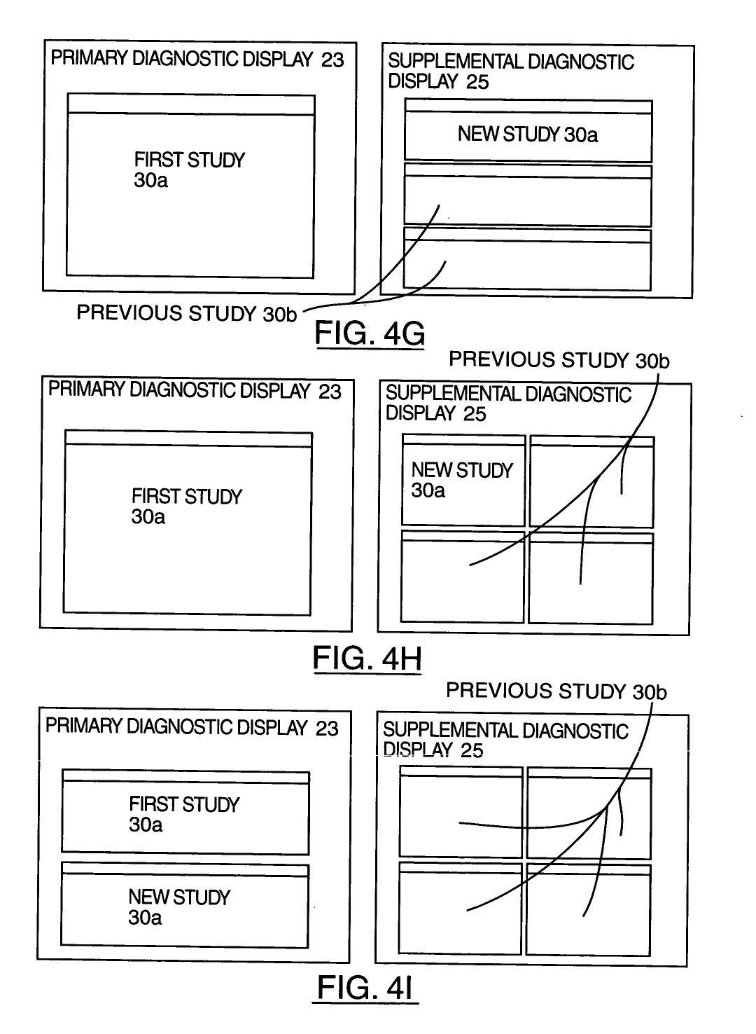

FIGS. 4A and 4B together illustrate the user-initiated tiling functionality of image display system 10 when user 11 directly engages the tiling functionality of image display system 10 by dragging a new study 30 onto a selected diagnostic display 23, 25. Specifically, FIG. 4A is a flowchart diagram that illustrates the process steps 100 that are executed by tiling module 14 and image processing module 12 to provide user-initiated tiling functionality in the situation where the user 11 selects a new study 30 and specifies where the study 30 should be positioned on diagnostic display 23, 25. It should be noted that the terminology “new study” will be used to describe the study that the user 11 has most recently selected for manipulation. Also, while this feature of user-initiated tiling module 14 will be discussed in respect of study(ies) 30, it should be understood that the user-initiated tiling functionality described is equally applicable to individual series 40 opened within a particular study 30.

At step (102), user 11 selects a new study 30a for user-initiated tiling in a number of ways. Firstly, user 11 can select a study 30 from study list 32 using a mouse 9 button and drag the study 30 to a particular location on primary or supplemental diagnostic display 23, 25 and then release the mouse 9 button. Secondly, user 11 can select a study 30 (or series 40) that is currently being displayed by selecting study toolbar 31 (or series toolbar 41) and dragging it to another position on primary or supplemental diagnostic display 23, 25. The latter option allows the user 11 to “swap” the respective positions of study(ies) 30 (or series 40). Again, it should be understood that these are only two exemplary methods of triggering the user-initiated tiling functionality of image display system 10 and that many other methods could be utilized.

At step (108), tiling module 14 displays visual “cues” or “targets” which help the user 11 determine where the current study 30a can be positioned or “dropped” (FIG. 4B). Specifically, tiling module 14 instructs display driver 22 to display indicia at the horizontal and vertical edges of the previous study 30b as shown in FIG. 4B where the new study 30a can be positioned (e.g. dotted lines at the horizontal and vertical edges). In addition, as shown on primary diagnostic display 23a, an indicia (e.g. a circle) is also displayed in the middle of previous study 30b to illustrate where user 11 could “drop” current study 30a in order to replace previous study 30b with new study 30a (FIG. 4B)

At step (110), tiling module 14 and image processing module 12 determines whether user 11 has dragged new study 30a to the middle (where the replacement circular indicia is displayed as shown in FIG. 4B) of previous study 30b and released the mouse 9 button. It should be understood at this point that user 11 could be dragging a study 30 from study list 32 or from a displayed position using the study toolbar 31 to “swap” positions with previous study 30b. If so, then at step (112), on primary diagnostic display 23b (FIG. 4B), image processing module 12 calls closure module 16 to close the previous study 30b and to open and position the new study 30a in place of the previous study 30b.

At step (114), tiling module 14 and image processing module 12 determine whether user 11 has dragged new study 30a to a horizontal edge (the dotted horizontal lines shown in FIG. 4B) of previous study 30b on a display (e.g. primary diagnostic display 23a) and released the mouse 9 button. It should be understood at this point that user 11 could be dragging a study 30 from study list 32 or from a displayed position using the study toolbar 31 to “swap” positions with previous study 30b. If so, then at step (116), tiling module 14 determines and selects an optimal study layout 36 for horizontal tiling within the selected diagnostic display 23, 25. It should be understood that the optimal study layout 36 will depend in part on which horizontal tiling indica is selected by the user 11. Other factors for consideration include the number of previous studies 30b already being displayed on selected diagnostic display 23, 25 and user preferences as stored within user preference database 24.

At step (120), tiling module 14 and image processing module 12 instruct display driver 22 to arrange new study 30a and previous study 30b in a horizontally tiled manner using the optimized study layout 36 (FIG. 4B). Specifically, study box 34 of previous study 30b is reduced in area such that previous study 30b and new study 30a can proportionally share the surface area of primary diagnostic display 23 (in this example) using the optimized study layout 36.

At step (118), tiling module 14 and image processing module 12 determine whether user 11 has dragged new study 30a to a vertical edge (i.e. the vertical dotted lines shown in FIG. 4B) of previous study 30b on a display (e.g. primary diagnostic display 23a) and released the mouse 9 button. It should be understood at this point that user 11 could be dragging a study 30 from study list 32 or from a displayed position using the study toolbar 31 to “swap” positions with previous study 30b. If so, then at step (121), tiling module 14 determines and selects an optimal study layout 36 for vertical tiling within the selected diagnostic display 23, 25 as discussed above. At step (122), tiling module 14 and image processing module 12 instruct display driver 22 to arrange new study 30a and previous study 30b in a horizontally tiled manner using the optimized study layout 36 (not shown).

FIGS. 4C, 4D, 4E, 4F, 4G, 4H and 4I illustrate the automatic tiling functionality of image display system 10 when user 11 selects a new study 30 (i.e. that hasn't been displayed before) for display on a diagnostic display 23, 25. Specifically, FIG. 4C is a flowchart diagram that illustrate the process steps 150 that are executed by tiling module 14 and image processing module 12 to provide image automatic tiling functionality on primary and supplemental diagnostic display 23, 25 when the user 11 selects a study 30 for automatic display (i.e. just by “double clicking” without dragging the study 30 to a diagnostic display 23, 25 or otherwise indicating the target position of study 30 for display). While this feature of tiling module 14 will be discussed in respect of study(ies) 30, it should be understood that the automatic tiling functionality described is equally applicable to individual series 40 opened within a particular study 30.

At step (152), user 11 initiates automatic tiling routine 150 by selecting study 30 from study list 32 (i.e. by “double clicking”).

At step (154), tiling module 14 determines whether the new study 30a is the first study 30 to be displayed. If so, then at step (155), study 30a is displayed in a maximum sized study box 34 on primary diagnostic display 23 as shown in FIG. 4D. That is, the optimal study layout 36 for this situation is to have a study box 34 having an area equal to the maximum display area of primary display area 35. Typically, medical practitioners select the most current study 30 available for display on the primary diagnostic display 23 and so this preference is reflected in the example opening protocol discussed here. However, it should be understood that many other opening protocols could be selected by user 11 and implemented within image display system 10.

If the new study 30a is not the first study 30 for display (as is the case in FIG. 4E where a first study 30a is already being displayed in primary diagnostic display 23), at step (156), tiling module 14 determines whether supplemental display area 37 is full. That is, it is determined whether the study layout 36 associated with supplemental diagnostic display 25 can be further subdivided. If study layout 36 can be further subdivided (as in the case shown in FIG. 4E, 4F, 4G), then at step (158), the study layout 36 is re-optimized. That is, new study 30a is considered along with any other studies 30 already being displayed within supplemental diagnostic display 25 and an optimal study layout 36 is selected. In the example shown in FIG. 4E, the new study 30b is the only study 30 to be displayed within supplemental diagnostic display 25. At step (160), a new study box 34a is positioned within the display area of supplemental diagnostic display 25 according to the optimized study layout 36. Again, as shown in FIG. 4E, the optimized study layout 36 is simply the entire area of the display area of supplemental diagnostic display 25.

As shown in FIGS. 4F, 4G, 4H, and 4I it is necessary to re-optimize study layout 36 each time a new study 30a is added to a number of previous studies 30b within supplemental display area 37. Each time, the pre-existing previous studies 30b are considered along with new study 30a and the optimal study layout 36 is selected based on a number of criteria. The criteria includes the number and type of studies 30 as discussed above. Also, it should be noted that the new study 30a is preferably positioned at the top or the top left position of the other previous studies 30b according to a user friendly image display protocol, although it should be understood that many other opening protocols could be utilized. Also, it should be understood that automatic tiling could be conducted in either a horizontal or vertical manner, depending on the optimal orientation and dimensions of the study 30 at issue as well as user presets stored in the user preference database 24.

It is contemplated that the determination of which display entities 27 (e.g. studies 30) are selected and arranged within display areas 35, 37 is preferably based on a specific set of rule-based criteria that determine the “relevancy” of various studies 30. The actual decision as to whether a particular display entity 27 (e.g. study 30) should be selected and where it should be positioned (e.g. alongside another existing display entity 27) can be made using relevancy rules. The specific rule-based criteria could be stored within user preference database 24 and implemented by tiling module 14 using relevancy rules as follows. This approach should be understood as noted above to apply to any type of display entity 27 (e.g. studies 30, series 40, images 50).

Tiling module 14 checks the characteristics (e.g. time of creation, image type, body type, modality type, procedure, patient, etc.) of a particular display entity 27 (e.g. study 30) and evaluates the associated relevancy rules. These relevancy rules can be used to determine whether a new display entity 27 should be selected for display and where it should be displayed (i.e. grouped alongside another dispay entity 27). Typically, data relevance is used to select and group display entities 27 within image display system 10. However, the other criteria noted above and many others could be used along with or in place of date relevance in such a determination.

If it is determined at step (156), that the supplemental display area is full (i.e. at FIG. 4H) then at step (162), tiling module 14 determines whether primary display area 35 is also full. That is, it is determined whether the study layout 36 associated with primary display area 35 can be further subdivided. If the study layout 36 of primary display area 35 can be further subdivided (as in FIG. 4H), then at step (164), the study layout 36 is re-optimized. That is, pre-existing previous studies 30b are considered along with new study 30a and the optimal study layout 36 that is formatted to contain the first study 30 and the newly introduced study 30 is selected. At step (166), the first study box 34 is resized and repositioned at the most prominent position (i.e. at the top of primary display area 35 as shown in FIG. 41) within study layout 36 and new study 30a is displayed below the first study box 34 (FIG. 41).

If the primary display area 35 is also full, then at step (168), tiling module 14 determines that the maximum number of study boxes 34 have been reached for each diagnostic display 23, 25 and returns. The maximum number of study boxes 34 that can be formed within a study layout 36 can be preset by a user (i.e. depending on a user's eyesight and personal preference) within in user preference database 24 or it can be a system default based on image quality-related considerations (e.g. image resolution, type of modality image at issue, etc.) It should be understood that many other responses when all display areas 35, 37 are “full” could be provided. For example, the oldest previous study 30 could be highlighted in case user 11 wishes to close the associated study box 34 to make room for new study 30a.

The resulting effect is that studies 30 are opened and tiled from right to left (i.e. from supplemental diagnostic display 25 to primary diagnostic display 23) such that studies 30 fill the right display (i.e. supplemental diagnostic display 25) before beginning to populate the left display (i.e. primary diagnostic display 23). The rationale for this opening and tiling protocol is that previous studies 30b (i.e. those studies 30 that were previously opened) are typically supplementary to the new studies 30a that are being opened. However, it should be understood that many different opening and tiling protocols could be implemented within tiling module 14. Also, as discussed above, various ways of selecting and grouping display entities 27 can be implemented using “relevancy rules” based on a number of characteristics (e.g. time of creation, image type, body type, modality type, procedure, patient, etc.)

FIGS. 5A and 5B illustrate the closure functionality of image display system 10 which allows user 11 to directly manipulate the size and placement of studies 30 within primary and supplemental display areas 35, 37 by dragging a desired study over unwanted studies 30 to close them. Specifically, FIG. 5A is a flowchart diagram that illustrates the process steps 200 that are executed by image processing module 12 and closure module 16 to provide study closure functionality as will be described. As noted above, while the general operation of image display system 10 will be discussed in respect of study(ies) 30, it should be understood that the closure functionality described is equally applicable to any kind of display entity 27 such as for example, individual series 40, images 50 and the like.

At step (202), user 11 selects HANDLE tag 97 (FIG. 5B) that is located in the bottom right corner of a first study box 34a. At step (204), closure module 16 determines whether HANDLE tag 97 is being used to drag first study box 34 over the spatial perimeter defined by second study box 34b. This is defined as where the position of the cursor holding and dragging HANDLE tag 97 passes over one of the perimeter edges (e.g. either left or right vertical edge or to or bottom horizontal edge or a combination thereof) of the second study box 34b as shown in FIG. 5B.

If this occurs, this action by user 11 is interpreted as meaning that user 11 has no interest in viewing the studies 30 associated with the “dragged over” study boxes 34 (e.g. study box 34b (FIG. 5B) or study boxes 34b, 34c, 34d (FIG. 5C)). Accordingly, then at step (206), closure module 16 and image processing module 12 instruct display driver 22 to close the “dragged over” study box(es) 34. At step (208), closure module 16 calculates the total display area that was taken up by first study box 34 (e.g. study box 34a in FIGS. 5B and 5C) and the other “dragged over” study boxes (e.g. study box 34b in FIG. 5B or study boxes 34b, 34c, 34d in FIG. 5C). At step (210), closure module 16 and image processing module 12 instruct display driver 22 to re-optimize the study layout 36 so that first study box 34a is positioned alongside any non-dragged study boxes 34 in an optimal manner on primary or supplemental display areas 35 or 37.

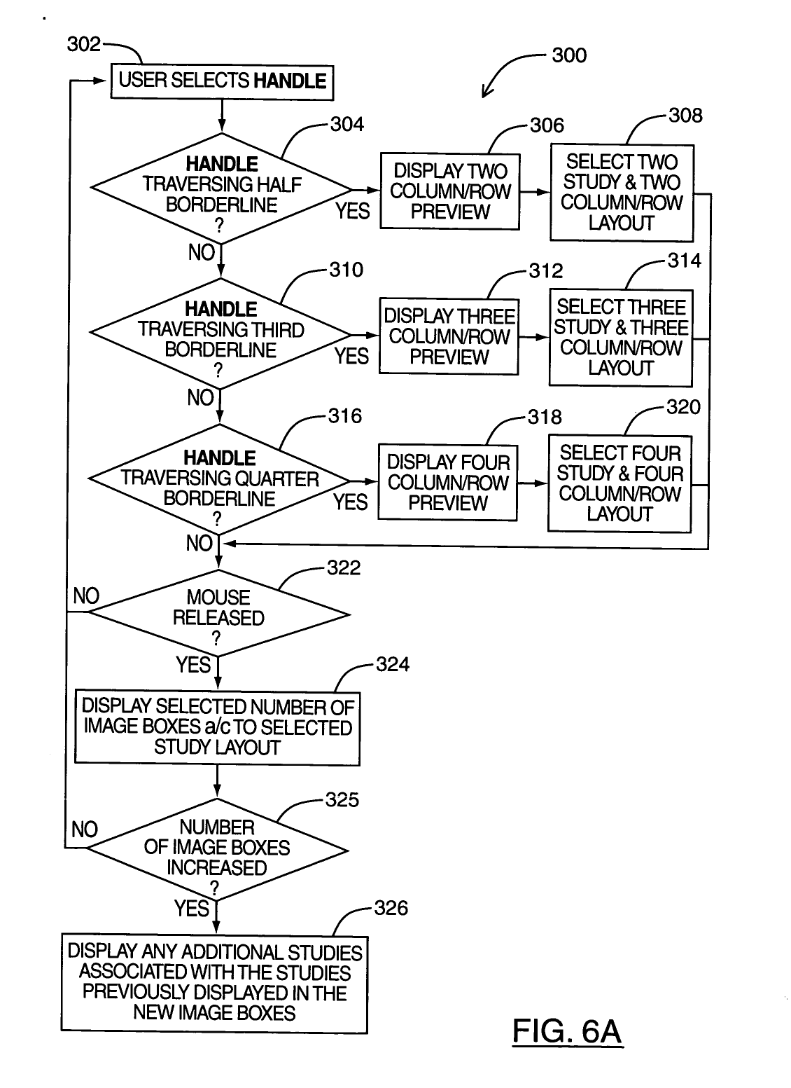

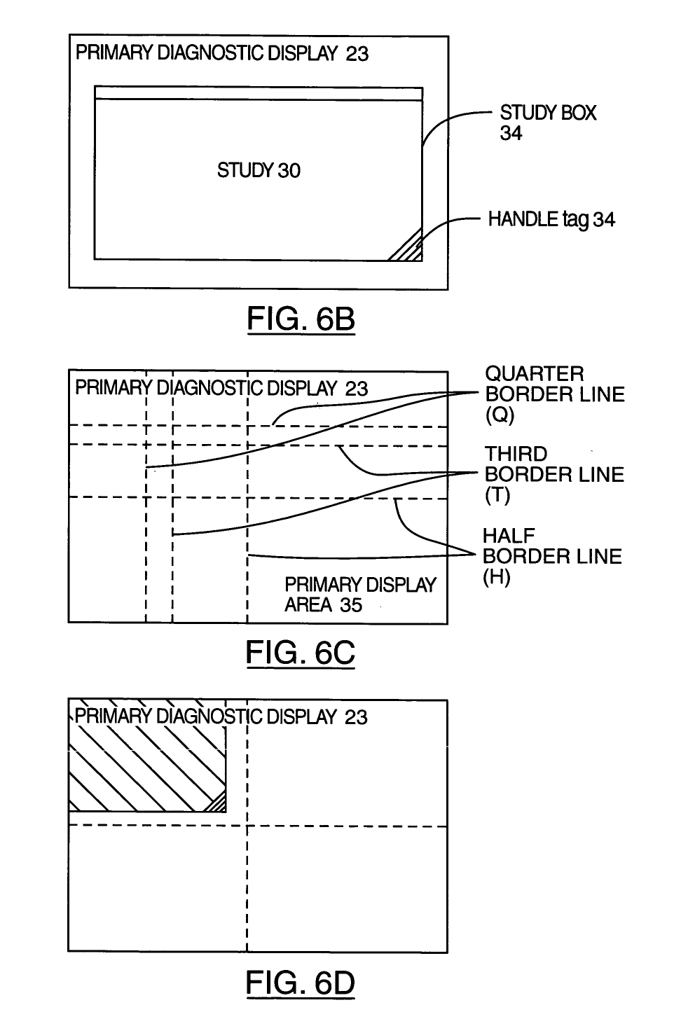

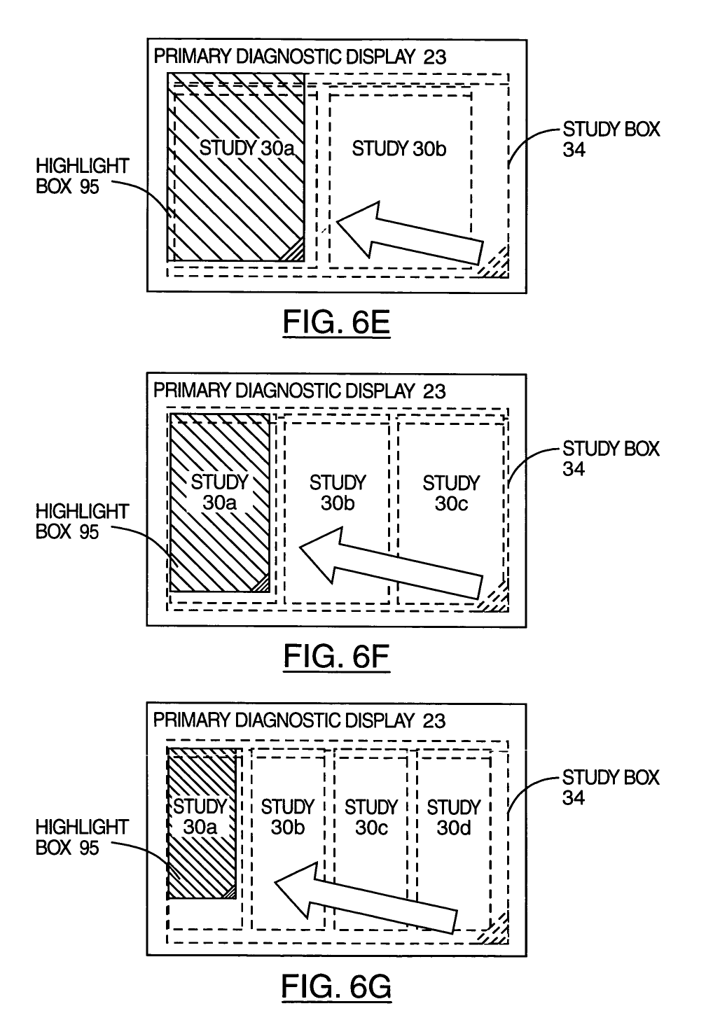

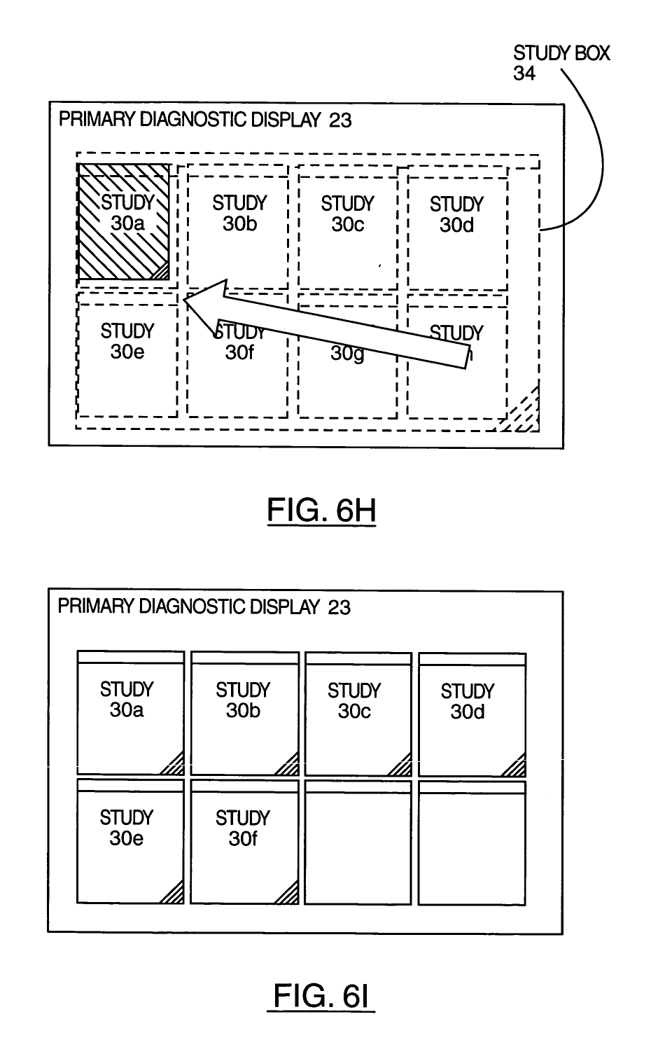

FIGS. 6A, 6B, 6C, 6D, 6E, 6F, 6G, 6H, and 61 illustrate the user-initiated retiling functionality of image display system 10. Specifically, FIG. 6A is a flowchart diagram that illustrates the process steps 300 that are executed by image processing module 12 and retiling module 18 to provide user-initiated retiling functionality on primary or supplemental diagnostic display 23, 25. The retiling functionality of image display system 10 is provided to allow a user 11 to display more of the open studies 30 that are available for a patient for comparison purposes. As noted above, while the general operation of image display system 10 will be discussed in respect of study(ies) 30, it should be understood that the retiling functionality described is equally applicable to any other kind of display entity 27 such as for example, individual series 40, images 50 and the like.

Generally, starting with a typical study box 30 as user 11 drags HANDLE tag 97 within the associated study box 30, a highlight box 95 is displayed (FIG. 6D) showing the user 11 where they have moved HANDLE tag 97 and resulting area selected. Also, as the user 11 drags HANDLE tag 97, the user 11 is also provided with dynamic previews of the resulting resized study boxes 34 (in dotted outline as shown in FIGS. 6E to 6I) that show user 11 how resized study boxes would appear if the user 11 released the HANDLE tag 97 (i.e. release mouse 9 button) at that point. Depending on where the user 11 releases the mouse 9, the box is then subdivided into multiple study boxes 30 so that more of the open study boxes are displayed as will be described.

Specifically, referring to FIG. 6B, the user 11 begins the retiling process by viewing a single study 30 displayed onscreen in a study box 34 as shown. Then, at step (302), user 11 selects HANDLE tag 97 on the study box 34 within primary display area 35. It should be understood that the retiling function is triggered when a user 11 selects the HANDLE tag 97 and drags it within the associated study box 34. As discussed above, if the user 11 selects the HANDLE tag 97 and drags it outside the associated study box 34 and over the perimeter of other study boxes 34, then the user 11 will be understood as wanting to expand the study box 34 and closure module 16 will be invoked to provide closure functionality to free up display area to allow for an expanded study box 34 as discussed above.

Display area 35 (or 37) contains horizontal and vertical borderlines. For example, as shown in FIG. 6C, study box 34 contains vertical and horizontal half border lines (H), vertical and horizontal third border lines (T), and vertical and horizontal quarter border lines (Q). As user 11 moves HANDLE tag 97 across these various horizontal and vertical borderlines, retiling module 18 displays the appropriate highlight box 95, determines the number of studies that the user 11 would like displayed and determine the corresponding column and/or row format. For example, by moving HANDLE tag 97 to the position shown in FIG. 6D, the HANDLE tag 97 traverses the vertical halfway borderline (H) and the horizontal halfway borderline (V). Accordingly, retiling module 18 determines that the user 11 would like to display two studies horizontally and two studies vertically and that the corresponding column/row format should be a two-column and two-row format. If the user 11 releases the mouse 9 button at this point, four studies 30 (if available for the patent at issue) will be displayed in a two-column and two-row format within display area 35.

It should be understood that the specific selection of column/row format depends on whether vertical or horizontal borderlines are traversed by HANDLE tag 97. Also, it should be understood that both horizontal and vertical borderlines can be traversed and that as such, each crossing is dealt with on an independent basis. That is, if both vertical and horizontal half borderlines are traversed as shown in FIG. 6D, then retiling module 18 will determine independently that two studies are desired to be displayed and two-column format selected (for vertical crossing) and another two studies desired to be displayed and a two-row format selected (for horizontal crossing). Together, this means that retiling module 18 will display the appropriate highlight box 95 (situated within both vertical and horizontal borderlines), determine that the user 11 would like four studies 30 displayed and determine the corresponding 2×2 column and row format for preview display and ultimately, implementation, if/when the user 11 releases the mouse 9 button.

Accordingly, referring back to FIG. 6A, at step (304), retiling module 18 and image processing module 12 determine whether HANDLE tag 97 has traversed the vertical or horizontal half line of original study box 30. If so, then at step (306), the appropriate highlight box 95 is displayed in dotted outline (e.g. FIG. 6E shows the case where the vertical half borderline has been traversed) and it is determined that user 11 wishes to display two studies 30 and the appropriate two-column preview is displayed (FIG. 6E). It should be noted that the original study box 34 continues to be displayed in the background. It should be understood that either two vertical columns and/or two horizontal columns will be displayed depending on whether the vertical and/or the horizontal half lines are traversed. As shown in FIG. 6E, based on the position of HANDLE tag 97, user 11 would like two studies 30 displayed within a two-column view (i.e. studies 30a and 30b) and retiling module 18 provides the appropriate layout preview. The layout preview is not implemented until user 11 releases mouse 9 button as will be described. At step (308), two study and two-column study layout 36 is selected, pending confirmation by user 11 (i.e. by releasing mouse 9 button).

At step (310), retiling module 18 and image processing module 12 determine whether HANDLE tag 97 has traversed the vertical or horizontal third line of original study box 30. If so, then at step (312), the appropriate highlight box 95 is displayed (e.g. FIG. 6F shows the case where the vertical third borderline has been traversed) it is determined that user 11 wishes to display three studies 30 and the appropriate three-column preview is displayed (FIG. 6F). It should be understood that either three vertical columns and/or three horizontal columns will be displayed depending on whether the vertical and/or the horizontal third lines are traversed. As shown in FIG. 6F, based on the position of HANDLE tag 97, user 11 would like three studies 30 to be displayed within a three-column view (i.e. studies 30a, 30b, 30c) and retiling module 18 provides the appropriate layout preview. The layout preview is not implemented until user 11 releases mouse 9 button as will be described. At step (314), three study and three-column study layout 36 is selected, pending confirmation by user 11 (i.e. by releasing mouse 9 button).

At step (316), retiling module 18 and image processing module 12 determine whether HANDLE tag 97 has traversed the vertical or horizontal fourth line of original study box 30. If so, then at step (312), the appropriate highlight box 95 is displayed (e.g. FIG. 6G shows the case where the vertical fourth borderline has been traversed) it is determined that user 11 wishes to display four studies 30 and the appropriate four-column preview is displayed (FIG. 6G). It should be understood that either four vertical columns and/or four horizontal columns will be previewed depending on whether the vertical and/or the horizontal quarter lines are traversed. As shown in FIG. 6G, based on the position of HANDLE tag 97, the user would like four studies 30 displayed within a four-column view (i.e. studies 30a, 30b, 30c, 30d) and the appropriate layout preview is provided. However, the layout preview is not implemented until user 11 releases mouse 9 button as will be described. At step (320), four study and three-column study layout 36 is previewed, implementation of which is pending confirmation by user 11 (i.e. by releasing mouse 9 button).

As discussed above, user 11 can manipulate HANDLE tag 97 so that it simultaneously traverses both vertical and horizontal borderlines. FIG. 6H illustrates the case where user 11 has manipulated HANDLE tag 97 so that it cross both the quarter vertical borderline and the half horizontal borderline within original study box 34. As a result, retiling module 18 displays the highlight box 95 as shown that user 11 has created by dragging HANDLE tag 97 in such a manner. Retiling module 18 also determines that the user 11 would like eight (i.e. 4 times 2) studies 30 displayed and determines that the optimal study layout 36 will be a four-column and two-row layout and provides the appropriate layout preview. If the user 11 releases mouse 9 button (as will be described below), the previewed layout will be implemented and all available studies (as shown in FIG. 6I only studies 30a, 30b, 30c, 30d, 30e and 30f are available to be displayed) for that patient will be displayed.

At step (322), retiling module 18 determines whether user 11 has released mouse 9 button when HANDLE tag 97 is at one of the above-noted positions. That is, if user 11 releases mouse 9 button while one of the column/row previews are being displayed, it is assumed that the user 11 has selected that column/row configuration for implementation. Accordingly, the study layout 36 associated with the column preview being displayed is then selected and implemented to form a series of study boxes 34 within display area 35, 37. Retiling module 18 and image processing module 12 then instruct display driver 22 to display the selected number of study boxes 34 as defined by the appropriate previewed study layout 36.

At step (325), retiling module 18 determines whether the number of study boxes 34 now being displayed is larger than the original set of studies 30 available for display. If so, then at step (326) any additional studies 30 (that were previously off-screen) are displayed within the additional study boxes 34 within display area 35, 37 as described above (FIG. 6I). As shown in FIG. 61, this feature allows user 11 to see more studies 30 for a patient onscreen once additional study boxes 34 have opened up. That is, a user 11 may start with a single study 30 displayed within display area 35 or 37 and select HANDLE tag 97 to resize the study boxes 34 within display area 35, 37. If user 11 releases mouse 9 button while one of the column/row previews are being displayed, it is assumed that the user 11 has selected the column/row preview displayed. This previewed study layout 36 is then implemented and a series of study boxes 34 are displayed within display area 35, 37. Any additional studies 30 associated with that original study 30 first displayed, will now fill the study boxes 34 so that more studies 30 are shown for that patient. In the case of FIG. 61, there are only six studies 30 available to fill the eight study boxes 34 of study layout 36.

As discussed above in respect of the tiling module 14, it is contemplated that the determination of which studies 30 are brought into study boxes 34 is preferably based on a specific set of rule-based criteria that determine the “relevancy” of various studies 30. The actual decision as to whether a particular display entity 27 (e.g. study 30) should be selected and where it should be positioned (e.g. alongside, above or below another existing display entity 27) can be made using relevancy rules. The specific rule-based criteria could be stored within user preference database 24 and implemented by tiling module 14 using relevancy rules as follows. This approach should be understood as noted above to apply to any type of display entity 27 (e.g. studies 30, series 40, images 50).

Retiling module 18 checks the characteristics (e.g. time of creation, image type, body type, modality type, procedure, patient, etc.) of a particular display entity 27 (e.g. study 30) and evaluates the associated relevancy rules. These relevancy rules can be used to determine whether a new display entity 27 should be selected for display and where it should be displayed (i.e. grouped alongside another dispay entity 27). Typically, data relevance is used to select and group display entities 27 within image display system 10. However, the other criteria noted above and many others could be used along with or in place of date relevance in such a determination.

FIGS. 7A, 7B, 7C, 7D, and 7E illustrate the mirroring functionality of image display system 10. Specifically FIG. 7A is a flowchart diagram that illustrates the process steps 400 that are executed by image processing module 12 and mirroring module 20 to provide mirroring functionality for a displayed study 30 on primary and supplemental diagnostic displays 23, 25. FIG. 7D illustrates the graphical user implementation of the MIRROR button 99 within study toolbar 31 when mirroring functionality has been enabled. FIGS. 7B, 7C and 7E illustrate an example of the mirroring function applied to a study 30. It should be understood that while the discussion of the mirroring functionality makes reference to a primary and supplemental displays 23, 25, it should be understood that mirroring could be applied to a primary display 23 along with any number of supplemental displays 25. Also, it should be understood that any kind of indicia (i.e. not necessarily a MIRROR button 99) could be provided by mirroring module 20 for user to select to enable mirring functionality of image display system 10. Finally, as noted above, while the general operation of image display system 10 will be discussed in respect of series 40, it should be understood that the mirroring functionality described is equally applicable to any other kind of display entity 27 such as for example, studies 30, images 50 and the like.

At step (402), user 11 selects a study 30 on an original display (i.e. either primary display 23 or supplemental display 25) for mirroring functionality using keyboard 7 and/or mouse 9. As discussed above, user 11 can select a study 30 for direct manipulation by selecting the HANDLE tag 97 associated with a study 30 (FIG. 7B). When the user 11 moves the HANDLE tag 97, the user 11 can change the dimensions of the study box 34 and move it over various display “surfaces” (FIG. 7C). In this way the user 11 can manually adjust the dimensions of the study box 34 so that it extends onto the adjacent display.

At step (404), it is determined whether user 11 has dragged the study to the adjacent monitor. If so, then at step (406), mirroring module 20 directs display driver 22 to expand study box 34 from being displayed only on original display onto both the original and adjacent displays. As shown in FIGS. 7B and 7C when user 11 selects HANDLE tag 97 of study box 34 on original display, and moves it over to an adjacent display 25, the study 30 is expanded onto two displays. Specifically, a particular image (e.g. image 1) of the various series 40 associated with study 30 is displayed within each series box 44 which are displayed within the expanded study box 34. The specific number of series boxes 44 that are displayed in this fashion can be selected by user 11 in a number of ways (e.g. using the retiling protocol discussed above, using a preferred series layout 46 stored within user preferences database 24, etc.)

At step (407), mirroring module 20 enables the display of MIRROR button 99 within study toolbar 31 as shown in FIG. 7B. This provides the user 11 with the option of selecting mirroring functionality. Selecting mirroring functionality will reduce the number of series 40 that are displayed but will allow the user 11 to “drill down” into the series being displayed on the original display as will be discussed.

At step (408), it is determined whether user 11 has selected MIRROR button 99. If so, then at step (410), mirroring module 20 instructs display driver 22 to remove the series 40 currently being displayed on the adjacent display from display. At step (412), mirroring module 20 applies a display protocol for the images within the series 40 displayed on original display. One example display protocol is the “advance one” display protocol which takes the series 40 shown on the original display and displays the same series 40 on the adjacent display but with the images advanced by one (FIG. 7E). For example, as shown in FIG. 7E, the first images of series 1, 2, 3, 4 are shown on primary display 23 and the second images of the series 1, 2, 3, and 4 are shown on supplemental display 25.

At step (414), mirroring module 20 causes the display of the resulting series 40 (i.e. advanced by one image) on the adjacent display. That, is mirroring module 20 mirrors the series 40 of study 30 being displayed on the original display (e.g. primary display 23) on the adjacent display (e.g. supplemental diagnostic display 25) according to a user preferred display protocol (e.g. an “advance-one” display protocol discussed above).

At step (416), it is determined whether the user 11 has deselected the mirroring functionality. It should be understood that the user 11 can deselect mirroring functionality in a number of ways. First, the user 11 can simply deselect the MIRROR button 99 from series toolbar 41. Secondly, user 11 can select and drag back the study box 34 from the adjacent display back to the original display using the HANDLE tag 97 as described above. If so, then at step (418), the mirroring function is disabled and the MIRROR button 99 is removed from study toolbar 31. If not, then step (416) is re-executed.

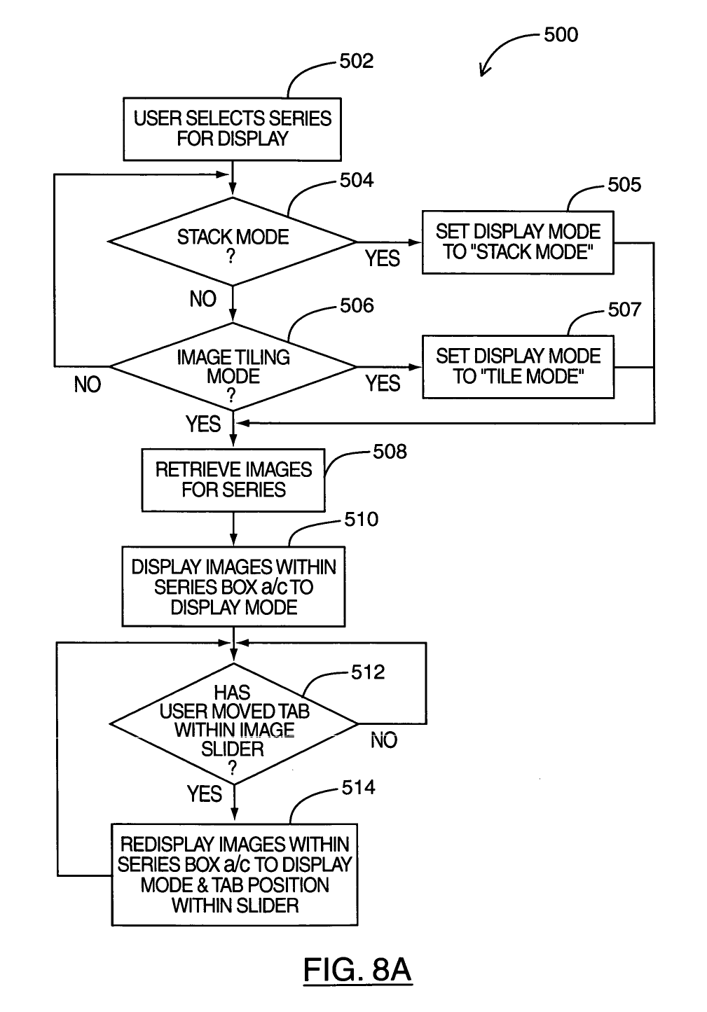

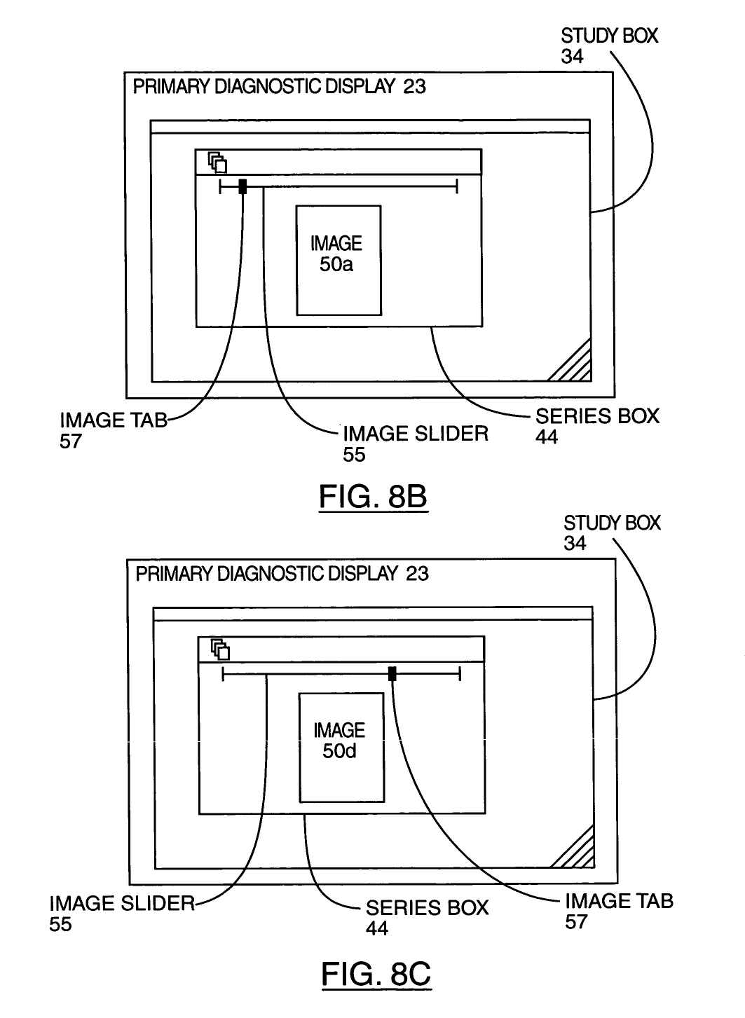

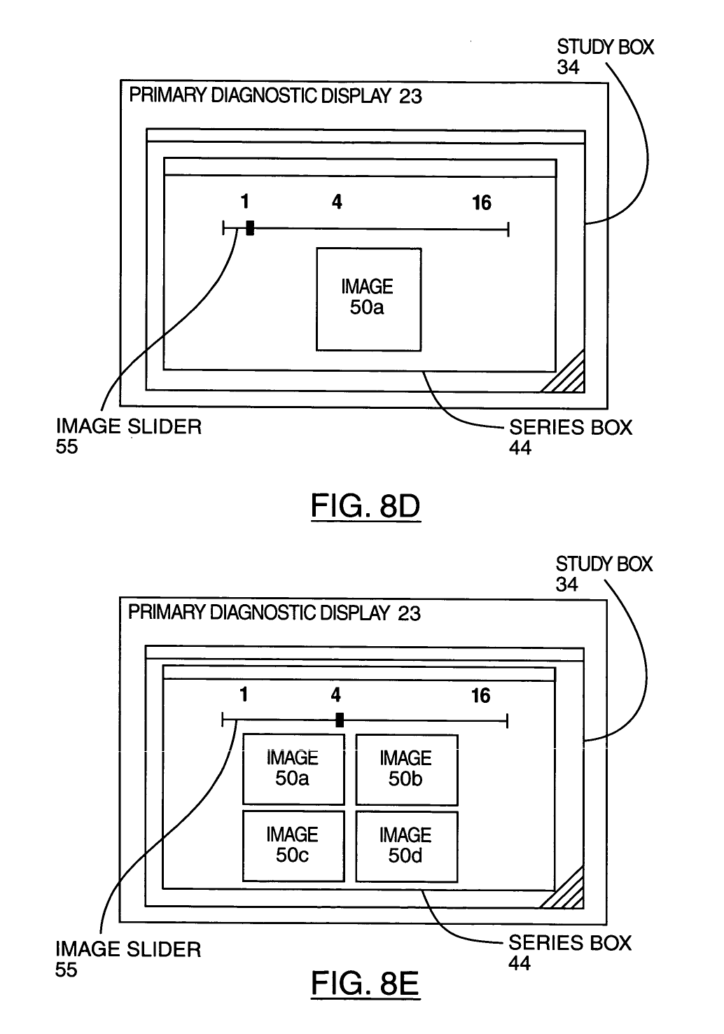

FIGS. 8A, 8B, 8C, 8D and 8E illustrate the specific image 50 manipulation functionality that is implemented by tiling module 14 and image processing module 12. Specifically, FIG. 8A is a flowchart diagram that illustrates the process steps 500 that are executed by image processing module 12 to provide image display functionality as will be described. As noted above, while the general operation of image display system 10 will be discussed in respect of the display of images 50 within series boxes 44, it should be understood that this display functionality is equally applicable to any kind of display entity 27 such as for example, studies 30, series 40 and the like.

At step (502), user 11 selects a particular series 40 for display within series box 44. At step (504), it is determined whether user 11 has requested that the images 50 of series 40 be displayed in stack mode (i.e. where images 50 are positioned on on-top of another so that only one image 50 is viable at any one time). It should be understood that there are many ways in which user 11 may request that the images 50 of series 40 be displayed in stack mode. For example, user 11 may select a menu option from a pull-down menu that is presented within series toolbar 41. Alternatively, user 11 may enter a “short-cut key” representation of such representation (e.g. “F1”).

If it is determined that user has requested that the images of series 40 are to be represented in stack mode, then at step (505), image processing module 12 sets the “display mode” to be “stack mode” and then proceeds to step (508) at which point image processing module 12 retrieves images 50 for the particular series 40. At step (510), image processing module 12 causes images 50 to be displayed in stack mode within series box 44 as shown in FIGS. 8B and 8C.

As shown, image 50a is displayed within series box 44 and an image slider 55 is provided at the top of series box 44 such that user 11 can progress through the various images in the image stack by sliding the image tab 57 along the length of image slider 55. As shown in FIG. 8B, a first image 50a is displayed within series box 44. At step (512), it is determined whether user 11 has selected image tab 57 and moved it along image slider 55. If so, then at step (514), another image 50d (i.e. further down in the stack) is selected and displayed within series box 44 (FIG. 8C). It should be understood that user 11 can also move through images 50 in “stack mode” using a variety of means (e.g. by rolling a mouse button forward/backward, or using up/down arrows on keyboard 7. Also, while image display of images 50 within series 40 has been discussed in respect of the movement of an image tab 57 along an image slider 55, it should be understood that many different types of indicia could be used instead (e.g. pull-down menu tabs, etc.)

At step (506), it is determined whether image tiling mode has been selected by user 11. Again, selection of “tiling mode” can be accomplished in a number of ways as discussed above in respect of the selection of stack mode (e.g. using pull-down menu option or short-cut key entry). If not, then image processing module 12 continues to monitor whether the user has selected a desired display mode and step (504) is re-executed.

If it is determined that user has requested that the images of series 40 are to be represented in tile mode, then at step (507), image processing module 12 sets the “display mode” to be “tile mode” and then proceeds to step (508) at which point image processing module 12 retrieves images 50 for the particular series 40. At step (510), image processing module 12 causes images 50 to be displayed in tile mode within series box 44 as shown in FIGS. 8D and 8E. As shown, in FIG. 8D a single image 50a is displayed within series box 44 and an image slider 55 is provided above series box 44 such that user 11 can select the number of images to be displayed within series box 44 by sliding the image tab 57 along the length of image slider 55. At step (512), it is determined whether user 11 has selected image tab 57 and moved it along image slider 55. If so, then at step (514), images 50a, 50b, 50c and 50d (i.e. original image 50a along with three other images further along in the series 40) are selected and displayed within series box 44 in a 2×2 configuration (FIG. 8E).

It should be understood that many other types of configurations are possible (e.g. 1×4 when four images are selected) and that once a certain configuration of images 50 are selected, the specific images being displayed can be advanced or retracted as discussed in respect of the “stack mode” approach (i.e. by rolling a mouse button or using up/down arrow keys etc.) Also, while image display of images 50 within series box 44 in certain configurations has been discussed in respect of the movement of an image tab 57 along an image slider 55, it should be understood that many different types of indicia could be used instead (e.g. pull-down menu tabs, etc.) by user 11 to select a particular image 50 configuration.

While image display system 10 has been described in the context of medical image management in order to provide an application-specific illustration, it should be understood that image display system 10 could also be applied to any other type of image or document display system.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A display system for displaying a new display entity and a previous display entity, said system comprising:
(a) a memory for storing data associated with the new and previous display entities;
(b) a processor coupled to said memory for selectively retrieving data associated with the new and previous display entities;
(c) a primary display coupled to said processor for displaying the new and previous display entities, said primary display having a primary display area being adapted to display at least one display entity box according to a first display entity layout;
(d) said processor further being adapted to:
(i) instruct the primary display to display the previous display entity in a display entity box defined by the first display entity layout;
(ii) determine whether the new display entity has been selected for display;
(iii) determine if primary display area is not full;
(iv) if (ii) and (iii) are both true, close the display entity box defined by the first display entity layout and determine a second display entity layout which accommodates the new and previous display entities; and
(v) display the new and previous display entities in the primary display area in display entity boxes that are defined by the second display entity layout.

2. The system of claim 1, wherein the new display entity box is positioned one of horizontally and vertically with respect to the previous display entity box.

3. The system of claim 1, wherein the new display entity box is positioned in place of the previous display entity box.

4. The system of claim 1, wherein said processor is further adapted to:
(A) provide an indicia that represents an entity layout;
(B) determine whether said indicia has been selected;
(C) if (B) is true, determine the entity layout represented by the indicia and utilize it as the second display entity layout.

5. The system of claim 1, wherein the new display entity is associated with a new display entity characteristic and the previous display entity is associated with a previous display entity characteristic, and the position of the new display entity relative to the previous display entity is determined based on the relationship between the new and previous display entity characteristics.

6. The system of claim 1, wherein the new display entity is associated with a new display entity characteristic and the previous display entity is associated with a previous display entity characteristic, and the new display entity is selected for display based on the relationship between the new and previous display entity characteristics.

7. The system of claim 1, further comprising a supplemental display coupled to said processor, said supplemental display having an supplemental display area and a third display entity layout which defines at least one display entity box within the supplemental display area and wherein said processor is further adapted to:
(vi) determine whether (ii) is true and (iii) is false, and if so, display the new display entity on the supplemental display area in a display entity box defined by the third display entity layout.

8. A method of displaying new and previous display entities on a primary display having a primary display area adapted to display at least one display entity box according to first display entity layout, said method comprising:
(a) storing data associated with the new and previous display entities;
(b) selectively retrieving data associated with the new and previous display entities;
(c) displaying the previous display entity on primary display in a display entity box defined by the first display entity layout;
(d) determining whether the new display entity has been selected for display;
(e) determining whether the primary display area is not full;
(f) if (d) and (e) are both true, closing the display entity box defined by the first display entity layout and determining a second display entity layout which accommodates the new and previous display entities; and
(g) displaying the new and previous display entities in primary display area in display entity boxes defined by the second display entity layout.

9. The method of claim 8, wherein the new display entity box is positioned one of horizontally and vertically with respect to the previous display entity box.

10. The method of claim 8, wherein the new display entity box is positioned in place of the previous display entity box.

11. The method of claim 8, wherein (g) further comprises:
(A) provide an indicia that represents an entity layout;
(B) determine whether said indicia has been selected;
(C) if (B) is true, determine the entity layout represented by the indicia and utilize it as the second display entity layout.

12. The method of claim 8, wherein the new display entity is associated with a new display entity characteristic and the previous display entity is associated with a previous display entity characteristic, and the position of the new display entity relative to the previous display entity is determined based on the relationship between the new and previous display entity characteristics.

13. The method of claim 8, wherein the new display entity is associated with a new display entity characteristic and the previous display entity is associated with a previous display entity characteristic, and the new display entity is selected for display based on the relationship between the new and previous display entity characteristics.

14. The method of claim 8, wherein new display entity is also selectively displayed on a supplemental display, said supplemental display having an supplemental display area and a third display entity layout which defines at least one display entity box within the supplemental display area, said method further comprising:
(g) if (d) is true and (e) is false, displaying the new display entity in the supplemental display area in a display entity box defined by the third display entity layout.

15. A display system for displaying first and second display entities, said system comprising:
(a) a memory for storing data associated with the first and second display entities;
(b) a processor coupled to said memory for selectively retrieving image data associated with the first and second display entities;
(c) a display coupled to said processor for displaying the first and second display entities, said display having a display area being adapted to display at least one display entity box according to a display entity layout;
(d) said processor further being adapted to:
(i) instruct the display to display the first and second display entities in the display area in display entity boxes defined by a first display entity layout;
(ii) determine whether the second display entity has been selected for closure;
(iii) if (ii) is true, close the at least one display entity box defined by the first display entity layout and determine a second display entity layout which accommodates the first display entity but not the second display entity; and
(iv) display the first display entity in the display area in a display entity box defined by the second display entity layout.

16. The system of claim 15, wherein the second display entity is selected for closure when the first display entity is dragged over the second display entity.

17. The system of claim 15, wherein the determination of the second display entity layout takes into account the image resolution of the display.

18. The system of claim 15, wherein the determination of the second display entity layout takes into account the image resolution of the first display entity.

19. A method of displaying first and second display entities on a display having a display area adapted to display at least one display entity box according to a display entity layout, said method comprising:
(a) storing data associated with the first and second display entities;
(b) selectively retrieving data associated with said first and second display entities;
(c) displaying the first and second display entities in the display area in display entity boxes defined by a first display entity layout;
(d) determining whether the second display entity has been selected for closure;
(e) if (d) is true, closing the at least one display entity box defined by the first display entity layout and determining a second display entity layout which accommodates the first display entity but not the second display entity; and
(f) displaying the first display entity in the display area in a display entity box defined by the second display entity layout.

20. The method of claim 19, wherein the second display entity is selected for closure when the first display entity is dragged over the second display entity.

21. The method of claim 19, wherein the determination of the second display entity layout takes into account the resolution of the display.

22. The method of claim 19, wherein the determination of the second display entity layout takes into account the resolution of the first display entity.

23. A display system for displaying first and second display entities, said system comprising:
(a) a memory for storing data associated with the first and second display entities;
(b) a processor coupled to said memory for selectively retrieving data associated with the first and second display entities;
(c) a display coupled to said processor for displaying the first and second display entities, said display having a display area having left and top sides, said display also being adapted to display at least one first display entity box according to a first display entity layout and at least one second display entity box according to a second display entity layout;
(d) said processor being further adapted to:
(i) instruct the display to display the first display entity in the first display entity box according the first display entity layout;
(ii) determine whether a second display entity layout has been selected;
(iii) if (ii) is true, close the first display entity box defined by the first display entity layout and display the first and second display entities within second display entity boxes defined by the second display entity layout.

24. The system of claim 23, wherein the processor is further adapted to:
(iv) determine whether a second display entity layout has been selected by determining whether a highlight box having dimensions that are smaller than the first display entity box has been selected.

25. The system of claim 24, wherein the processor is further adapted to:
(v) determine the vertical and horizontal dimensions of the highlight box;
(vi) determine whether the highlight box has been selected for implementation;
(vii) if (vi) is true, then determining the second display entity layout such that the vertical and horizontal dimensions of the second display entity boxes substantially correspond to the vertical and horizontal dimensions of the highlight box.

26. The system of claim 25, wherein the display area includes a vertical borderline, and wherein the processor is further adapted to determine if the vertical dimension of highlight box is less than or equal to the distance between the left side of the display area and the vertical borderline and if so, set the vertical dimension of the second display entity boxes to be equal to the distance between the left side of the display area and the vertical borderline.

27. The system of claim 25, wherein the display area includes a horizontal borderline, and wherein the processor is further adapted to determine if the horizontal dimension of highlight box is less than or equal to the distance between the top side of the display area and the horizontal borderline and if so, set the horizontal dimension of the second display entity boxes to be equal to the distance between the top side of the display area and the horizontal borderline.

28. The system of claim 26, wherein the display area also has a right side and wherein the vertical borderline is positioned within display area at a position selected from the group consisting of: halfway between the left and right sides, a third of the way between the left and right sides, a quarter of the way between the left and right sides.

29. The system of claim 27, wherein the display area also has a bottom side and wherein the horizontal borderline is positioned within display area at a position selected from the group consisting of: halfway between the top and bottom sides, a third of the way between the left and right sides, a quarter of the way between the left and right sides.

30. The system of claim 23, wherein the first display entity is associated with a first display entity characteristic and the second display entity is associated with a second display entity characteristic, and the position of the second display entity relative to the first display entity is determined based on the relationship between the second and first display entity characteristics.

31. The method of claim 23, wherein the first display entity is associated with a first display entity characteristic and the second display entity is associated with a second display entity characteristic, and the first display entity is selected for display based on the relationship between the first and second display entity characteristics.

32. A method of displaying first and second display entities on a display having a display area having left and top sides, said display also being adapted to display at least one first display entity box according to a first display entity layout and at least one second display entity box according to a second display entity layout, said method comprising:
(a) storing image data associated with the first and second display entities;
(b) selectively retrieving image data associated with the first and second display entities;
(c) displaying the first display entity in the first display entity box according the first display entity layout;
(d) determining whether a second display entity layout has been selected; and
(e) if (d) is true, closing the first display entity box defined by the first display entity layout and displaying the first and second display entities within second display entity boxes defined by the second display entity layout.

33. The method of claim 32, further comprising:
(iv) determining whether a second display entity layout has been selected by determining whether a highlight box having dimensions that are smaller than the first display entity box has been selected.

34. The method of claim 33, further comprising:
(v) determining the vertical and horizontal dimensions of the highlight box;
(vi) determining whether the highlight box has been selected for implementation;
(vii) if (vi) is true, then determining the second display entity layout such that the vertical and horizontal dimensions of the second display entity boxes substantially correspond to the vertical and horizontal dimensions of the highlight box.

35. The method of claim 34, wherein the display area includes a vertical borderline, and said method further includes determining if the vertical dimension of highlight box is less than or equal to the distance between the left side of the display area and the vertical borderline and if so, setting the vertical dimension of the second display entity boxes to be equal to the distance between the left side of the display area and the vertical borderline.

36. The method of claim 35, wherein the display area includes a horizontal borderline, and said method further includes determining if the horizontal dimension of highlight box is less than or equal to the distance between the top side of the display area and the horizontal borderline and if so, setting the horizontal dimension of the second display entity boxes to be equal to the distance between the top side of the display area and the horizontal borderline.

37. The method of claim 36, wherein the display area also has a right side and wherein the vertical borderline is positioned within display area at a position selected from the group consisting of: halfway between the left and right sides, a third of the way between the left and right sides, a quarter of the way between the left and right sides.

38. The method of claim 37, wherein the display area also has a bottom side and wherein the horizontal borderline is positioned within display area at a position selected from the group consisting of: halfway between the top and bottom sides, a third of the way between the left and right sides, a quarter of the way between the left and right sides.

39. A display system for displaying a display entity, said display entity having display sub-entities, said system comprising:
(a) a memory for storing data associated with the display entity;
(b) a processor coupled to said memory for selectively retrieving data associated with the display entity;
(c) an original display coupled to said processor for displaying the display entity, said original display having an original display area adapted to display at least one display sub-entity;
(d) an adjacent display coupled to said processor for displaying the display entity, said adjacent display having an adjacent display area that is adapted to display at least one display sub-entity;
(e) said processor further being adapted to:
(i) display the display entity within a display entity box within the original display area;
(ii) determine whether mirroring of the display entity has been selected; and
(iii) if (ii) is true, display the first display sub-entities of the display entity within the original display area and the second display sub-entities of the display entity within the adjacent display area.

40. The system of claim 39, wherein said original and adjacent displays are adapted to display a display entity box and wherein said processor is further adapted to:
(i) determine whether the display entity box has been selected and expanded from the original display to the adjacent display;
(ii) if (i) is true, displaying an indicia and determining whether the indicia has been seleted; and
(iii) if (ii) is true, determining that mirroring of the display entity has been selected.

41. A method for displaying a display entity on an original display and an adjacent display, said display entity having display sub-entities, the original display having an original display area and the adjacent display, said method comprising:
(a) storing data associated with the display entity;
(b) selectively retrieving data associated with the display entity;
(c) displaying the display entity within a display entity box within the original display area;
(d) determining whether mirroring of the display entity has been selected; and
(e) if (d) is true, displaying the first display sub-entities of the display entity within the original display area and the second display sub-entities of the display entity within the adjacent display area.

42. The method of claim 41, wherein said original and adjacent displays are adapted to display a display entity box, said method further comprising:
(f) determining whether the display entity box has been selected and expanded from the original display to the adjacent display;
(g) if (f) is true, displaying an indicia and determining whether the indicia has been selected by the user; and
(h) if (g) is true, determining that mirroring of the first and second series has been selected.
